(19) United States
(12) Patent Application Publication
(10) Pub. No.: US 2022/0087386 A1
(43) Pub. Date: Mar. 24, 2022

(54) MULTI-FUNCTIONAL ACCESSORY ATTACHMENT SYSTEM FOR ELECTRONIC DEVICES

(71) Applicant: CATALYST LIFESTYLE LIMITED, Hong Kong (HK)

(72) Inventors: Joshua Wright, Hong Kong (HK); June Lai, Hong Kong (HK)

(73) Assignee: CATALYST LIFESTYLE LIMITED, Hong Kong (HK)

(21) Appl. No.: 17/477,131

(22) Filed: Sep. 16, 2021

Related U.S. Application Data
(60) Provisional application No. 63/080,180, filed on Sep. 18, 2020.

(51) Int. Cl. A45C 11/00; A45C 1/06

(52) U.S. Cl. CPC A45C 11/00; A45C 1/06; A45C 2011/003; A45C 2011/002; A45C 2200/15

(57) ABSTRACT

A protective case for an electronic device, the protective case includes a body defining a cavity for receiving the electronic device, the body includes one or more walls arranged about a perimeter of the cavity. The one or more walls define a plurality of apertures extending through the body. The plurality of apertures are shaped and sized to receive and retain one or more retention components coupled to an accessory.

### CROSS-REFERENCE TO RELATED APPLICATION

The present application claims the priority benefit of U.S. Provisional Application No. 63/080,180, entitled “PROTECTIVE CASES HAVING A MULTI-FUNCTIONAL ACCESSORY ATTACHMENT SYSTEM” and filed Sep. 18, 2020, the entire contents of which is incorporated by reference herein.

### TECHNICAL FIELD

The present specification generally relates to protective cases that cover at least a portion of electronic devices and, more specifically, cases that include a plurality of apertures for receiving accessories.

### BACKGROUND

As background, electronic devices (e.g., smartphones, tablets, or the like) may be retained within protective cases that prevent the electronic devices from getting scratched dinged, marred, contacted with fluid (e.g., become wet), or the like. In addition, protective cases may absorb an impact sustained when dropped. In order to provide additional protection against falls or fluid contact, protective cases may be arranged around the device while still allowing functional access to the screen and/or buttons of the device. Users may desire to attach certain accessories to the protective case in order to minimize the amount of items that have to be carried, such as, for example, wallets, stands, key rings, clips, carabiners, trinkets, supplemental battery packs, solar panels, or the like. Existing protective cases do not have a standard system that allows for mounting of different accessories via the same connectors on the case.

### SUMMARY

According to a first aspect, a protective case for an electronic device, the protective case including a body defining a cavity for receiving the electronic device, the body includes one or more walls arranged about a perimeter of the cavity. The one or more walls define a plurality of apertures extending through the body. The plurality of apertures are shaped and sized to receive and retain one or more retention components coupled to an accessory.

According to a second aspect, a system including: an accessory; at least one retention component couplable to the accessory; and a protective case for an electronic device. The protective case includes a body defining a cavity for receiving the electronic device, the body includes one or more walls arranged about a perimeter of the cavity. The one or more walls define a plurality of apertures extending through the body, each one of the plurality of apertures are shaped and sized to receive and retain the at least one retention component therein. The retention component extends at least partially through at least one of the plurality of apertures to attach the accessory to the protective case.

According to a third aspect, a protective system for an electronic device, the protective system including: a protective case including a body including one or more sidewalls and a rear wall, a first accessory, and a second accessory. The one or more sidewalls define a plurality of apertures extending through the body. Each one of the plurality of apertures shaped and sized to receive and retain at least one retention component therein. The first accessory is attached to the protective case by a retention component extending through a first set of the plurality of apertures. The second accessory is attached to the protective case at a position other than the first set of the plurality of apertures.

These and additional features provided by the embodiments described herein will be more fully understood in view of the following detailed description, in conjunction with the drawings.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals and in which:

FIG. 1A depicts a front view of an illustrative protective case having a plurality of apertures disposed within the protective case according to one or more aspects shown and described herein;

FIG. 1B depicts a perspective view of the protective case of FIG. 1A, according to one or more aspects shown and described herein;

FIG. 1C depicts a perspective view of another protective case having a plurality of alternative apertures, according to one or more aspects shown and described herein;

FIG. 2A depicts a detailed perspective view of one of the plurality of apertures of the protective case of FIGS. 1A and 1B, according to one or more aspects shown and described herein;

FIG. 2B depicts a cross-sectional view of one of the plurality of apertures of the protective case of FIGS. 1A and 1B through the line II-II of FIG. 2A, according to one or more aspects shown and described herein;

FIG. 2C depicts a cross-sectional view of another aperture of the protective case of FIGS. 1A and 1B through the line II-II of FIG. 2A, according to one or more aspects shown and described herein;

FIG. 2D depicts a cross-sectional view of yet another aperture of the protective case of FIGS. 1A and 1B through the line II-II of FIG. 2A, according to one or more aspects shown and described herein;

FIG. 3A depicts a perspective view of a wallet accessory designed to be attached to the protective case of FIGS. 1A and 1B via the plurality of apertures, according to one or more aspects shown and described herein;

FIG. 3B depicts another perspective view of the wallet accessory of FIG. 3A, according to one or more aspects described herein;

FIG. 3C depicts an exploded view of the wallet accessory of FIG. 3A, the protective case of FIGS. 1A and 1B, and a plurality of attachment pins for attaching the wallet accessory to the protective case, according to one or more aspects described herein;

FIG. 3D depicts a perspective view of the wallet accessory of FIG. 3A in a closed position when attached to the protective case of FIGS. 1A and 1B via the plurality of attachment pins of FIG. 3B, according to one or more aspects described herein;

FIG. 3E depicts a first view of the wallet accessory of FIG. 3A in a stand configuration for holding the protective case of FIGS. 1A and 1B in a viewing position, according to one or more aspects described herein;

FIG. 3F depicts a second view of the wallet accessory of FIG. 3A in the stand configuration of FIG. 3E, according to one or more aspects described herein;

FIG. 4A depicts a perspective view of an illustrative attachment pin, according to one or more aspects shown and described herein;

FIG. 4B depicts a side perspective view of the attachment pin of FIG. 4A, according to one or more aspects shown and described herein;

FIG. 5A depicts a close-up view of the attachment pin of FIG. 4A extending through one of the plurality of apertures of the protective case of FIGS. 1A and 1B to secure first portion of an accessory thereto, according to one or more aspects described herein;

FIG. 5B depicts a close-up view of the attachment pin of FIG. 4A extending through another one of the plurality of apertures of the protective case of FIGS. 1A and 1B to secure a second portion of the accessory of FIG. 5A thereto according to one or more aspects described herein;

FIG. 6A depicts a perspective view of the protective case protective case of FIGS. 1A-1B having an accessory attached thereto via a multi-portion retention piece extending through one of the plurality of apertures, according to one or more aspects described herein;

FIG. 6B depicts an exploded view of the multi-portion retention piece of FIG. 6A, according to one or more aspects described herein;

FIG. 6C depicts a first perspective view of a lower portion of the multi-portion retention piece of FIG. 6A, according to one or more aspects described herein;

FIG. 6D depicts a second perspective view of the lower portion of the multi-portion retention piece of FIG. 6A, according to one or more aspects described herein;

FIG. 6E depicts a first perspective view of a upper portion of the multi-portion retention piece of FIG. 6A, according to one or more aspects described herein;

FIG. 6F depicts a second perspective view of the upper portion of the multi-portion retention piece of FIG. 6A, according to one or more aspects described herein;

FIG. 6G depicts a perspective view of the multi-portion retention piece of FIG. 6A, according to one or more aspects described herein;

FIG. 6H depicts a top perspective view of the multi-portion retention piece of FIG. 6A, according to one or more aspects described herein;

FIG. 7A depicts a perspective view of the protective case of FIGS. 1A-1B, with a first accessory being attached to a first set of the plurality of apertures via a first retention component and a second accessory being attached to a second set of the plurality of apertures via a second retention component, according to one or more aspects described herein;

FIG. 7B depicts a perspective view of a portion of the first accessory and first retention component of FIG. 7A, according to one or more aspects described herein;

FIG. 7C depicts a perspective view of a clip assembly of the first retention component of FIG. 7A, according to one or more aspects described herein;

FIG. 7D depicts a perspective view of the second accessory and second retention component of FIG. 7A, according to one or more aspects described herein;

FIG. 7E depicts a side perspective view of the second accessory and second retention component of FIG. 7A, according to one or more aspects described herein;

FIG. 8A depicts a rear perspective view of a protective case including a plurality of apertures, with a first accessory being attached to the protective case via a set of the plurality of apertures and a second accessory being attached to a rear surface of the protective case, according to one or more aspects described herein;

FIG. 8B depicts a perspective view of the second accessory of FIG. 8A, according to one or more aspects described herein;

FIG. 9 depicts a front view of an illustrative protective case having a plurality of elongated apertures disposed within the protective case, according to one or more aspects shown and described herein;

FIG. 10A depicts a perspective view of an illustrative electronic device having a body defining one or more apertures, according to one or more aspects described herein; and

FIG. 10B depicts a perspective view of an illustrative electronic device having a body defining one or more elongated apertures, according to one or more aspects described herein.

### DETAILED DESCRIPTION

The present disclosure generally relates to a protective case for an electronic device, the protective case having a plurality of apertures formed in the protective case. The plurality of apertures generally provide connection points for various accessories that can be attached to the protective case, such as, for example, a wallet accessory, a stand accessory, a key ring accessory, a clip accessory, a carabiner accessory, a trinket accessory, a supplemental battery pack, a solar panel, or the like. The apertures of the protective case may be particularly shaped and/or sized to receive retention components that facilitate attachment of various accessories to the protective case. A plurality of different retention components may be received in the plurality of apertures to facilitate attachment of a plurality of different accessories to the protective case. In aspects, for example, a particular retention component may be an attachment pin, and at least one of the plurality of apertures in the protective case may be particularly sized and/or shaped to receive the attachment pin and restrain the attachment pin to hold an accessory on the protective case. In another example, a particular retention component may be a multi-portion retainer element, with each portion of the multi-portion retainer element including an insertion portion that is retained into at least one of the plurality of apertures. In another example, a particular retention component may be an attachment loop that is routed through at least one of the plurality of apertures and an attachment member that is attached to an accessory. The various retention components descried herein facilitate attachment of accessories to an electronic device disposed in the protective case without hindering operation of the electronic device (e.g., blocking the touchscreen of the electronic device, blocking a field of view of an imaging device of the electronic device, blocking one or more buttons, blocking one or more switches, or the like). Various aspects of the protective case, the apertures, and various illustrative accessories will be described in greater detail herein.

An electronic device may include any electronic device such as a pager, PDA, cellphone, smart phone, tablet, laptop, or the like. Electronic devices according to the present disclosure may include one or more buttons, switches (e.g., a sliding switch, such as a muting switch), and/or the like. As will be described herein, an electronic device may be positioned within the protective case. The protective case may provide a protective and/or a waterproof housing around the electronic device. However, the present disclosure is not limited to only protective cases and/or waterproof cases. That is, a “protective case” as used herein as generally any apparatus that can be configured to surround at least a portion of the electronic device, including, for example, a bumper case, a device frame, a sleeve, or the like.

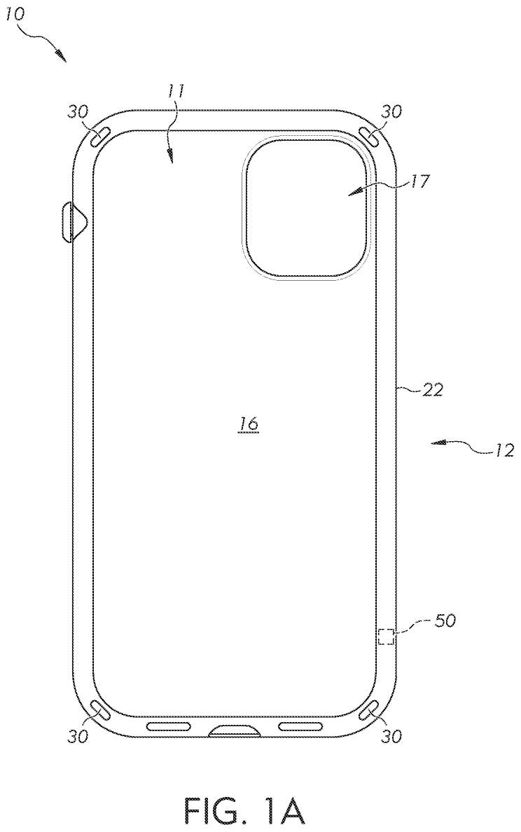

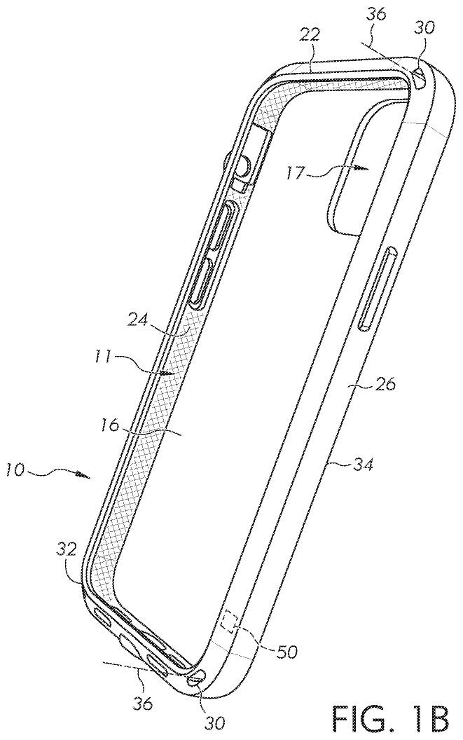

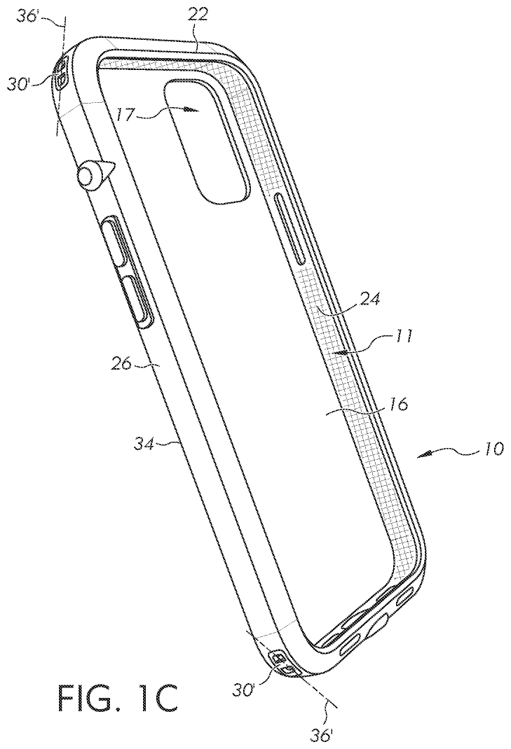

Referring now to FIGS. 1A and 1B, an aspect of a protective case 10 is generally depicted. FIG. 1A depicts a front view of the protective case 10, while FIG. 1B depicts a perspective view of the protective case 10. The protective case 10 generally includes a body 12. The body 12 includes a rear wall 16 and one or more sidewalls 22 that extend transversely from the rear wall 16 around the edges of the rear wall 16 to define a cavity 11 within which an electronic device may be received. While the aspect depicted in FIGS. 1A and 1B is a body 12 having a single piece assembly (e.g., a bumper case), the present disclosure is not limited to such. That is, the body 12 may be separable into one or more components to allow for insertion of the electronic device into the cavity 11 defined by the body 12. In aspects, the protective case 10 may provide a waterproof housing for the electronic device positioned therein.

In aspects, the rear wall 16 of the body 12 may have one or more features that are arranged to correspond to one or more features of a backside of an electronic device when the electronic device is received within the cavity 11 of the protective case 10. For example, as depicted in FIG. 1A, the rear wall 16 of the body 12 may include one or more camera windows 17 that are aligned with one or more components of a camera device (e.g., a lens and/or flash) to allow for the capture of images by the electronic device when the electronic device is positioned within the protective case 10. In addition, the rear wall 16 of the body 12 may be shaped and sized to generally correspond to the shape and size of a particular electronic device such that the electronic device, when received in the protective case 10, fits within the cavity 11 defined by the body 12. While not depicted in FIGS. 1A and 1B, in some aspects, the rear wall 16 may be omitted such that the body 12 only includes the one or more sidewalls 22.

In some aspects, the one or more sidewalls 22 may extend directly from peripheral edges of the rear wall 16 such that the rear wall 16 defines the one or more sidewalls 22 of the body 12. The one or more sidewalls 22 may be arranged to correspond to a perimeter of the electronic device when the electronic device is positioned within the body 12. With reference to FIG. 1B, the one or more sidewalls 22 may define an interior side 24 and an exterior side 26. The electronic device may be positioned on the interior side 24 of the sidewall 22 when positioned within the body 12. In some aspects, the one or more sidewalls 22 may curve over the electronic device when the electronic device is inserted within the cavity 11 such that a portion of the one or more sidewalls 22 covers a portion of a face of the electronic device (e.g., a bezel of the electronic device or a portion of a bezel, a rim, or the like). In such aspects, the sidewalls 22 may have a front facing portion (not depicted) that generally faces in a direction opposite the rear wall 16 of the body 12.

While the protective case 10 depicted in FIGS. 1A and 1B is a single body, it should be understood that aspects are envisioned where the protective case 10 includes a multi-piece construction. For example, in aspects, the protective case 10 includes a multi-piece body including a front portion (e.g., similar to the one or more sidewalls 22) and a rear portion (e.g., similar to the rear wall 16) that are separably coupled to one another. In such aspects, each of the front portion and the rear portion may be single integral articles or may be assemblies of sub-body components. For example, in aspects, the front portion may be assembled to and disassembled from the rear portion repeatedly (e.g., to allow for insertion and removal of the electronic device). In such aspects, when the front portion is assembled to the rear portion around an electronic device, a fluid tight seal (e.g., a watertight seal and/or an airtight seal) may be formed between the front portion and the rear portion to prevent ingress or egress of liquid, dirt, or other debris, into the protective case 10, thereby protecting the electronic device from contact with liquid, dirt, or debris. That is, such a protective case 10 having a multi-piece construction, when assembled, may provide a waterproof housing for the electronic device positioned therein.

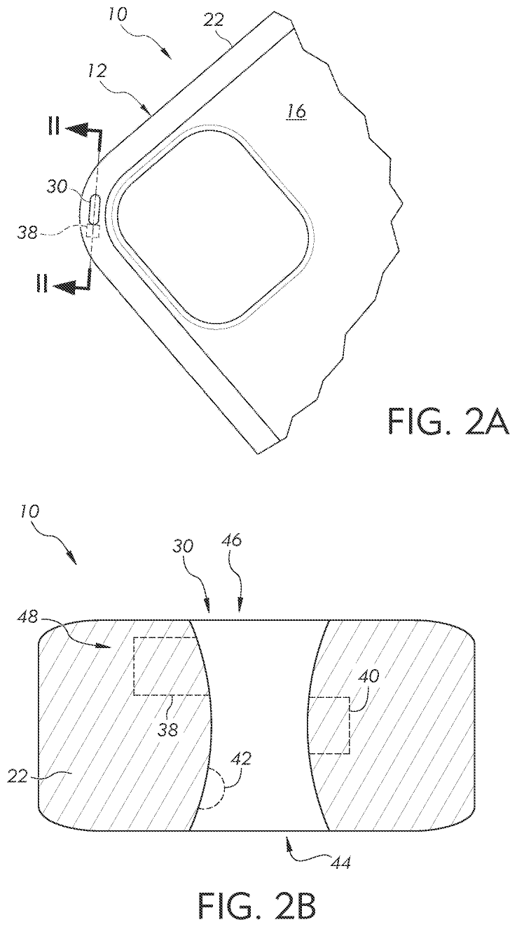

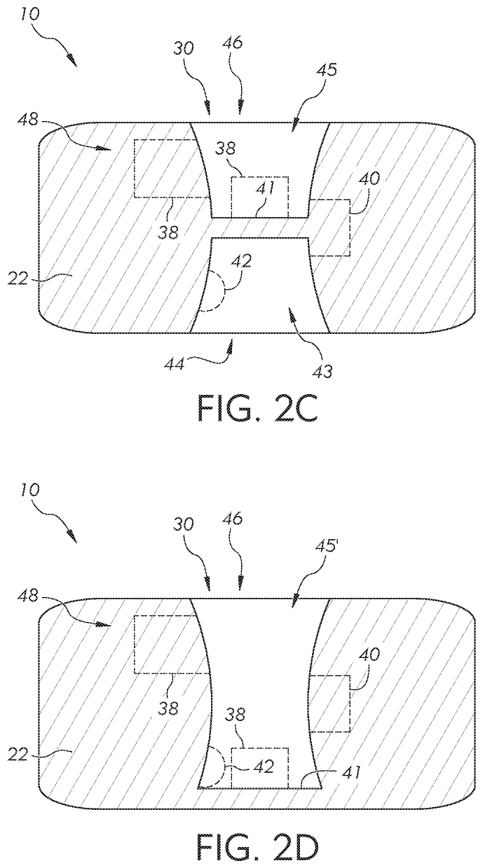

Referring to FIGS. 1A, 1B, and 2A, the body 12 of the protective case 10 also defines a plurality of apertures 30 that extend through the body 12 of the protective case 10. That is, the plurality of apertures 30 each forms a bore through the body 12 of the protective case 10. In aspects, each of the plurality of apertures 30 extends through the entire thickness of the sidewalls 22, such that the plurality of apertures 30 extend from a front surface 32 of the sidewalls 22 to a rear surface 34 of the sidewalls 22. In aspects, the rear surface 34 of the sidewalls 22 corresponds to a rear surface of the rear wall 16 (e.g., such that entirety of the rear surface of the protective case 10 is a planar or substantially planar surface). In aspects, the rear surface 34 of the sidewalls 22 protrudes outward or extends inward from the rear surface of the rear wall 16 such that the sidewalls 22 form a peripheral surface that does not lie in the same plane as the rear wall 16. The rear surface 34 of the sidewalls 22 may extend beyond the rear wall 16 such that the sidewalls 22 form a ridge that extends around the periphery of the rear wall 16. While the each of the plurality of apertures 30 is depicted to extend through the one or more sidewalls 22, aspects are also envisioned where at least a portion of the plurality of apertures 30 extend through the rear wall 16.

As depicted in FIG. 1B, each of the plurality of apertures 30 may include an aperture axis 36. In the depicted aspect, each aperture axis 36 of each of the plurality of apertures 30 extends perpendicular or substantially perpendicular (e.g., within 5° of perpendicular) to the rear wall 16. In aspects, each aperture axis 36 may extend in directions other than perpendicular to the rear wall 16 (e.g., parallel to the rear wall 16, at a 45° angle relative to the rear wall 16, etc.). For example and with reference to FIG. 1C, an alternative aperture 30′ for the protective case 10 may extend through the exterior side 26 of the sidewalls 22 across the corners thereof in a direction that is transverse to the front-to-back direction of the protective case 10. That is, the aperture 30′ may extend from the exterior side 26 of one of the sidewalls 22 to the exterior side 26 of the adjacent sidewall 22, such that the aperture 30′ extends through the corner of the protective case 10. In some embodiments, the aperture 30′ includes an aperture axis 36′ that may extend in a direction parallel to a tangent line of the curvature of the corner of the protective case 10. It should be understood that in embodiments where the protective case 10 is a waterproof case, the apertures 30′ may extend through corners of the protective case 10 in a manner such that the apertures 30′ are not open to the cavity 11 of the protective case 10 (e.g., such that the interior side 24 of the sidewalls 22 is between the aperture 30′ and the cavity 11). While FIG. 1C only depicts two apertures 30′, it should be appreciated that the two corners of the protective case 10 not depicted in FIG. 1C may also contain apertures 30′ therein. In some embodiments, the case may have a combination of both apertures 30 (FIGS. 1A-1B) and apertures 30′. Referring again to FIG. 1B, in aspects, each aperture axis 36 extends through the center of one of the plurality of apertures 30. In aspects, each of the plurality of apertures 30 is symmetrical about a line extending perpendicular to the aperture axis 36 to accommodate the reception and securing of symmetrically-shaped retention components. Aspects are envisioned where at least some of the plurality of apertures 30 are asymmetrical, depending on the retention elements that the plurality of apertures 30 are designed to receive or desired shock absorption characteristics.

In the depicted aspect, the plurality of aperture axes 36 extend parallel to one another. Aspects are also envisioned where the plurality of aperture axes 36 extend in different directions from one another depending on the implementation. For example, in aspects, at least one of the plurality of aperture axes 36 extends at an angle from one of the sidewalls 22 such that an end of at least one of the plurality of apertures 30 is disposed on the interior side 24 or the exterior side 26 defined by the sidewalls 22. For example, in aspects, one of the plurality of apertures 30 may include a first end disposed on the front surface 32 and a second end disposed on the interior side 24 to conceal a portion of a retention component (e.g., an attachment pin) or facilitate an end of the retention component engaging with the electronic device when the electronic device is disposed in the cavity 11. It should be appreciated that aspects are envisioned where one or more of the plurality of apertures 30 extends in multiple directions, or changes direction within the protective case 10. For example, in aspects, one or more of the plurality of apertures 30 may include a first portion extending in a first direction, a second portion extending in a second direction that is different from the first direction, and a bend extending between the first direction and the second direction. In such aspects, such different portions of the plurality of apertures 30 extending in different directions may include a separate aperture axis 36. In aspects, one or more of the plurality of apertures may extend along a curved profile and not include a linear aperture axis.

In aspects, the apertures 30 may generally have any size or shape. The sizes and/or shapes of the plurality of apertures 30 may correspond to a shape and/or size of retention component, as described in greater detail herein. While not depicted in FIGS. 1A, 1B, 2A, and 2B, each one of the apertures 30 may have a cross sectional shape that is particularly configured to restrain a particular retention component. For example, in aspects, the cross-sectional shapes of each one of the plurality of apertures 30 are designed to restrain an attachment pin having a particular cross-sectional shape.

In such aspects, as depicted in FIG. 2B, for example, the plurality of apertures 30 may have an hourglass-like axial profile (e.g., along each aperture axis 36, see FIG. 1B). In such aspects, as one of the plurality of apertures 30 is traversed from a first opening 44 to a second opening 46 thereof, the cross sectional shape of the aperture 30 may be generally hourglass-like. That is, a cross section of the aperture 30 may be widest at the openings 44 and 46 of the aperture 30 and narrowest at a point in between the openings of the aperture 30 (e.g., a midpoint between the first opening of the aperture 30 and the second opening of the aperture 30). The wider cross-sections at the ends of the aperture 30 may facilitate insertion of an attachment pin therein, while the narrower cross section may secure the attachment pin within the aperture 30 once the attachment pin is inserted therein. It should be understood that such an hourglass shape is merely one illustrative example, and other cross sectional shapes (including regular and irregular shapes) are contemplated. For example, the apertures 30 may have various other cross sectional geometries, including, without limitation, elliptical cross sections, square cross sections, rectangular cross sections, triangular cross sections, and the like. Further, it should be understood that apertures 30 with different cross sectional geometries may be formed in the body 12 of the protective case 10. In some aspects, the apertures 30 may each have a consistent cross sectional shape when traversed from the first opening of each aperture 30 to a second opening of each aperture 30 (e.g., a cylindrical shape).

Referring still to FIG. 2B, in aspects, the internal walls of each of the plurality of apertures 30 may optionally include one or more engagement features. In the example depicted in FIG. 2B, the aperture 30 is shown to include both a negative engagement feature 40 (e.g., a recess, a groove, an indentation, a negative thread, a concavity, or the like) and a positive engagement feature 42 (e.g., a protrusion, a flange, a positive thread, a convex portion, or the like). It should be appreciated that any number and/or combination of such engagement features may be included on the internal walls of the plurality of apertures 30 in accordance with the present disclosure. The particular engagement features included may vary in accordance with retention components that may be inserted or otherwise engage with the plurality of apertures 30 to attach one or more accessories to the protective case 10. For example, in embodiments, the positive engagement feature 42 (e.g., a protrusion) may correspond in shape to a negative engagement feature (e.g., a groove) in a retention component used to attach an accessory to the protective case 10. In such an example, the positive engagement feature 42 may be positioned within the aperture 30 such that, when the retention component is inserted in the aperture 30 to a desired position, the positive engagement feature 42 engages with (e.g., is inserted in) the negative engagement feature of the retention component to facilitate retaining the retention component in the aperture 30. In aspects, each of the plurality of apertures 30 includes the same set of engagement features (e.g. the positive engagement feature 42 and/or the negative engagement feature 40) for compatibility with the same retention components or set of retention components. In aspects, the plurality of apertures 30 may include different sets of engagement features to facilitate compatibility with different retention components (or sets of retention components) in each aperture. In some aspects, the internal walls of the apertures 30 may be shaped, sized, and/or have surface features to receive and retain a press fit object inserted within the aperture, as described in greater detail herein.

In some aspects, each one of the apertures 30 may have an opening diameter, for example, of about 0.1 millimeters (mm) to about 25 mm (e.g. 0.1 mm, 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, 10.0 mm, 10.5 mm, 11.0 mm, 11.5 mm, 12.0 mm, 12.5 mm, 13.0 mm, 13.5 mm, 14.0 mm, 14.5 mm, 15.0 mm, 15.5 mm, 16.0 mm, 16.5 mm, 17.0 mm, 17.5 mm, 16.0 mm, 16.5 mm, 17.0 mm, 17.5 mm, 18.0 mm, 18.5 mm, 19.0 mm, 19.5 mm, 20.0 mm, 20.5 mm, 21.0 mm, 21.5 mm, 22.0 mm, 22.5 mm, 23.0 mm, 23.5 mm, 24.0 mm, 24.5 mm, 25.0 mm, and any and all diameters between such diameters). As used herein, the term “opening diameter” refers to the length of a line extending perpendicular and through the aperture axis 36 associated with the referenced aperture 30 between two points on an interior surface defining the referenced aperture 30 at an opening (e.g., the first and second openings 44 and 46 depicted in FIG. 2B). The opening of the apertures 30 is generally at a location that marks a transition between the an outer wall of the body 12 (e.g., an outer wall of the one or more sidewalls 22) and a sloped surface of a wall of the aperture 30. Similarly, the apertures 30 may have an opening radius of about 0.05 mm to about 13 mm. As used herein, the opening radius refers to the radius of the opening of the apertures 30 in the body 12 (e.g., at the aperture axes 36). In some aspects, the openings of the apertures 30 in the body may be a regular shape (e.g., circular, square shaped, triangular, or the like) or may be an irregular shape (e.g., pill shaped or the like).

In some aspects, one or more magnets may be formed into the body 12 on or around the plurality of apertures 30. For example, with reference to FIGS. 2A and 2B, the protective case 10 is depicted to optionally include a magnet 38 inserted therein in close proximity to one of the plurality of apertures 30. In aspects, as depicted in FIG. 2B, the body 12 may be formed with one or more receptacles 48 for insertion of the magnet 38. The receptacle 48 may include a slot, groove, cavity, or other feature designed to receive and secure the magnet 38 therein. While the magnet 38 is depicted to be proximate to a wall of one of the plurality of apertures 30, aspects are also envisioned where the magnet 38 is embedded within the body 12 and not exposed to an environment outside the protective case 10. In aspects, the receptacle 48 extends from a side wall of one of the plurality of apertures 30 (e.g., similar to the negative engagement feature 40) to facilitate insertion of the magnet 38 therein via the plurality of apertures 30. The protective case 10 may include any number, arrangement, and distribution of magnets and receptacles in accordance with the present disclosure. In aspects, the protective case 10 includes a magnet proximate to each one of the plurality of apertures 30 to facilitate retention of a magnetic retention component in each of the plurality of apertures 30. In aspects, the protective case 10 is constructed of a suitable magnetic material and the magnet 38 may be omitted. In aspects, the interior walls of one or more of the plurality of apertures 30 may be coated with a magnetic material and the magnetic material serves as the magnet 38.

In aspects, the magnet 38 may be disposed proximate to one of the plurality of apertures 30 to facilitate imparting an attractive magnetic force on a retention component (e.g., a pin or the like, as described herein) inserted in the aperture 30 to retain the retention component therein. In some aspects, the material of the body 12 may be formed of a magnetic material. That is, the entire body 12 may be formed of a magnetic material or a portion of the body 12 (e.g., an area of the body at, near, and/or surrounding the apertures 30) is formed of a magnetic material. Examples of suitable magnetic materials (e.g., various ferromagnetic materials) should generally be understood.

While FIGS. 1A and 1B depict four (4) apertures 30, the present disclosure is not limited to such. That is, the body 12 of the protective case may have any number of apertures 30, including 1, 2, 3, 4, 5, 6, 7, 8, 9, 10, or greater numbers of apertures 30. Further, while FIGS. 1A, 1B, 2A, and 2B depict the apertures 30 disposed generally at the corners of the protective case 10, the present disclosure is not limited to such. That is, the apertures 30 may be disposed anywhere on the body 12 of the protective case 10. For example, the apertures 30 may be disposed at or near an upper portion of the protective case 10, a lower portion of the protective case 10, and/or a side of the protective case 10.

In some aspects, when not filled with an attachment pin as described herein, the apertures 30 may function in a manner similar to that of air-filled shock absorbers. That is, the body 12 of the protective case 10 may be formed of a shock absorbing material at an area surrounding the apertures 30, particularly areas disposed radially outward of the apertures 30, such that the body 12 absorbs impacts at such areas. In aspects, portions of the body 12 (e.g., surrounding the plurality of apertures 30) are constructed of a shock absorbing material (e.g., a visco-elastic polymer, rubber, neoprene, silicone, or other suitable material) having a reduced impulse response as compared to a remainder of the body 12. In aspects, such a shock absorbing material may be distributed around the one or more sidewalls 22 to impart a shock resistant quality to the protective case 10 to protect an electronic device disposed in the cavity 11 from vibrational energy associated with drops or other impact events. In aspects, a shock-absorbing insert may be disposed within one or more of the plurality of apertures 30 to provide increased shock absorbance to the protective case 10. In one example, the apertures 30 may be disposed at one or more corners of the body 12 as depicted in FIGS. 1A-1C-2A such that the material of the body 12 located radially outward from each of the apertures 30 absorbs impacts from drops or the like at the corners of the protective case 10.

While the present disclosure generally relates to the apertures 30 being oriented such that they extend between a front and a rear of the body 12 of the protective case 10 as described herein, the present disclosure is not limited to such. That is, in some aspects, the apertures 30 may be oriented in any other fashion, such as, for example, extending laterally through the body 12 of the protective case 10 (e.g., substantially parallel to the plane in which the rear wall 16 of the protective case 10 is oriented). Other orientations are also contemplated and the present disclosure is not limited to any particular orientation. In some aspects, all of the apertures 30 may have the same orientation. In other aspects, certain ones of the apertures 30 may have a different orientation relative to other certain ones of the apertures 30. That is, one or more of the apertures 30 may be oriented in a first particular manner, another one or more of the apertures 30 may be oriented in a second particular manner different from the first particular manner, and so on.

While the present disclosure generally relates to the apertures 30 extending through the body 12 of the protective case 10 such that apertures 30 create an opening on either side of the protective case 10, the present disclosure is not limited to such. That is, in some aspects, one or more of the plurality of apertures 30 extends only partially through the body 12 (e.g., from the front surface 32 and/or the rear surface 34 into the body 12). With reference to FIG. 2C, in such aspects, the plurality of apertures 30 may include a base 41 within the body 12. The base 41 may be disposed between the first opening 44 and the second opening 46. In aspects, the base 41 may be disposed anywhere in the aperture 30 between the first opening 44 and the second opening 46. The base 41, the aperture 30, and the first opening 44 may define a first pocket 43. The base 41, the aperture 30, and the second opening 46 may define a second pocket 45. The base 41 may be positioned substantially in the center of the aperture 30, such that a volume of the first pocket 43 and a volume of the second pocket 45 are substantially the same. However, in aspects, the base 41 may be positioned away from the center of the aperture 30, such that one of the volume of the first pocket 43 and the volume of the second pocket 45 is greater than the other of the volume of the first pocket 43 and the volume of the second pocket 45. While FIG. 2C depicts the base 41 as being generally parallel with the outer surfaces of the protective case 10 (e.g., parallel to the front surface 32 and/or the rear surface 34 of the body 12 as depicted in FIG. 1B for example), the present disclosure is not limited to such. That is, the base 41 may be positioned at an angle relative to one or more of the outer surfaces of the protective case 10. In addition, while FIG. 2C depicts the base 41 as being generally planar, the present disclosure is not limited to such. That is, the base 41 may have one or more nonplanar surfaces in some embodiments. The first pocket 43 and the second pocket 45 may each receive a retention component therein. Each of the first pocket 43 and the second pocket 45 may include a negative engagement feature 40 and/or a positive engagement feature 42 as described herein. With reference to FIG. 2D, the base 41 may be positioned at an end of the aperture 30, such that the aperture 30 only includes a single opening (e.g., the second opening 46 depicted in FIG. 2D). In such aspects, the aperture 30 includes a single pocket 45′ for receiving a retention component. In aspects, the base 41 may be positioned at another end of the aperture 30, such that the aperture 30 only includes the first opening 44. With reference to FIGS. 2C and 2D, in aspects, the base 41 may include an engagement feature (e.g., a magnet, clip, clasp, cavity, protrusion, groove) that engages with a corresponding feature at an end of an retention component to facilitate retaining the retention component within the plurality of apertures 30.

With reference to FIGS. 1A and 1B, in aspects, the body 12 of the protective case 10 may optionally include one or more engagement features 50 other than the plurality of apertures 30 (e.g., in addition to, or as an alternative to the plurality of apertures 30). In aspects, the one or more engagement features 50 may include bores, holes, receptacles, niches, and/or the like that are particularly shaped, sized, configured, and/or oriented for the purposes of providing a point on the protective case 10 for fixture or attachment of an accessory as described herein. In aspects, the one or more engagement features 50 may include protrusions, bumps, knobs, projections, posts, or similar components extending a distance from the body 12 of the protective case 10 and providing a point of fixture or attachment of an accessory as described herein. Such protrusions, bumps, knobs, projections, posts, or similar components may be particularly shaped, sized, configured, and/or oriented for the purposes of providing a point on the protective case 10 for fixture or attachment of an accessory as described herein. In an example, the one or more engagement features 50 may include a post or the like that is inserted into a cavity of an accessory that is attached to the protective case 10. In another example, the one or more engagement features 50 may include a hole or slit that is sized to receive a retention component (e.g., a clip, an attachment pin, or the like) associated with an accessory that is attached to the protective case. In aspects, the one or more engagement features 50 include an arrangement of engagement features designed to engage with a particular retention component or accessory. For example, the one or more engagement features 50 may include a set of holes or posts for engaging with a set of inverse features (e.g., pegs, rods, holes) in a retention component or engagement feature.

In aspects, the one or more engagement features 50 may be placed proximate to one or more of the plurality of apertures 30 to facilitate retaining a retention component in the plurality of apertures 30. In an example, the one or more engagement features 50 may include an extension extending over an end of one of the plurality of apertures 30. The extension may be moved to facilitate insertion of a retention component in the plurality of apertures and then moved into contact with the retention component to retain the retention component in a desired position. In aspects, the one or more engagement features 50 includes an elastic structure for retaining a portion of an accessory. In aspects, the one or more engagement features 50 include separable elements that are attached to the body 12 via an attachment mechanism (e.g., an adhesive, magnet, clip, or the like). In such aspects, the one or more engagement features 50 may be removed when not needed.

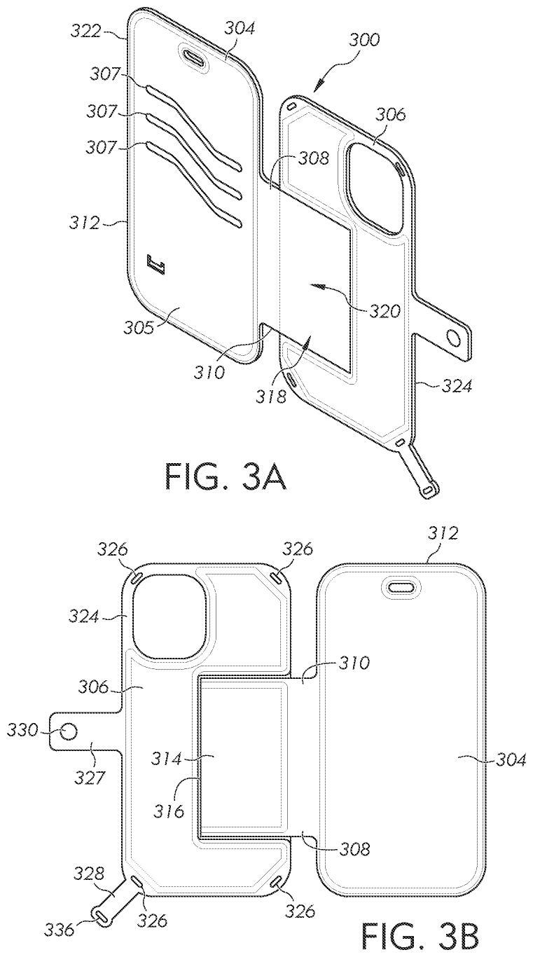

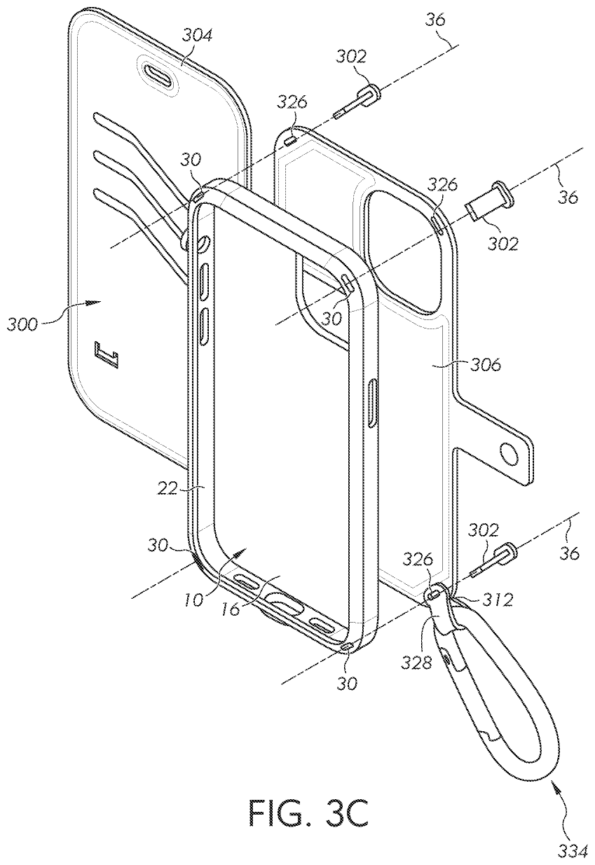

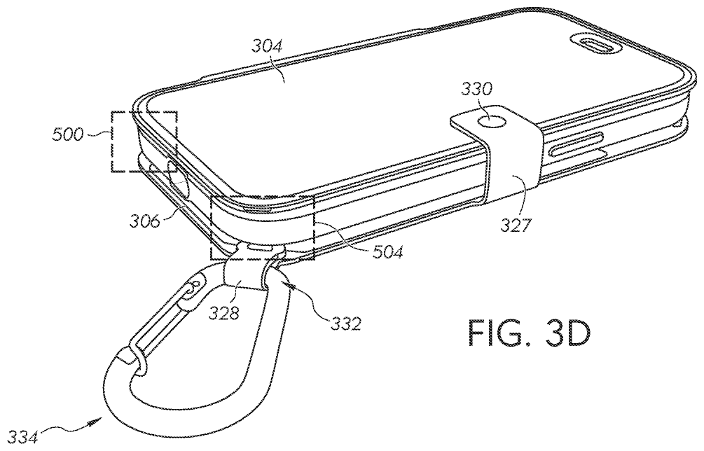

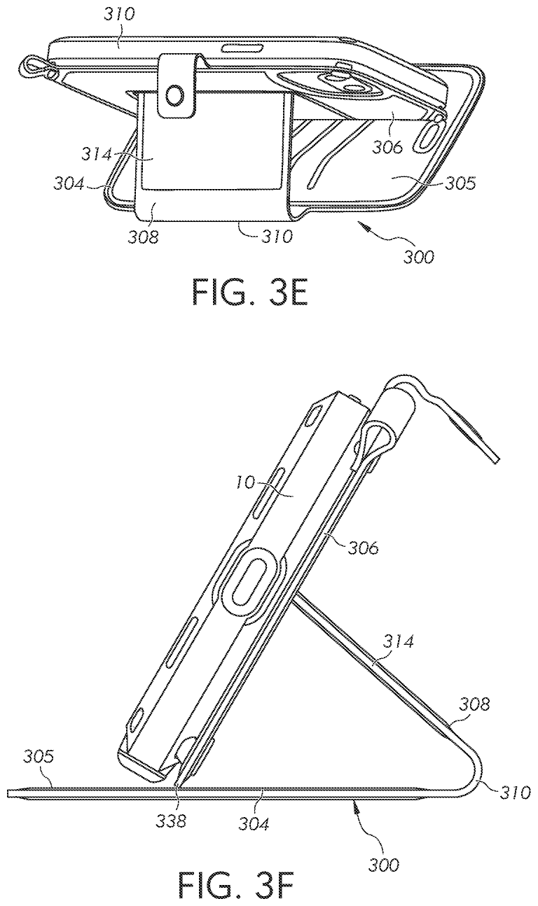

FIGS. 3A-3E depict various views of a wallet accessory 300 that is attachable to the protective case 10 via the plurality of apertures 30. FIG. 3A depicts a first perspective view of the wallet accessory 300. FIG. 3B depicts a second perspective view of the wallet accessory 300. FIG. 3C depicts an exploded view of the wallet accessory 300, the protective case 10, and a plurality of retention components 302 for attaching the wallet accessory 300 to the protective case 10. FIG. 3D depicts a perspective view of the wallet accessory 300 in a closed position when attached to the protective case 10 via the plurality of retention components 302. FIG. 3E depicts a first view of the wallet accessory 300 in a stand configuration for holding the protective case 10 in a viewing position. FIG. 3F depicts a second view of the wallet accessory 300 in the stand configuration.

Referring now to FIGS. 3A-3B, the wallet accessory 300 includes a front portion 304, a rear portion 306, and a hinge portion 308 extending between the front portion 304 and the rear portion 306. The front and rear portions 304 and 306 are generally movable relative to one another via the hinge portion 308 to facilitate placing the wallet accessory 300 in the various configurations described herein. In aspects, the front portion 304, the rear portion 306, and the hinge portion 308 are constructed of fabric-backed laminates including layers of a suitable cover material (e.g., rubber, plastic, or polymer-based material) including fabric backings. The fabric-backed laminates may be shaped (e.g., via die cutting) and attached to one another to form the peripheral shape of the wallet accessory 300. In aspects, the hinge portion 308 and the front portion 304 are formed from the same fabric-backed laminate comprising two layers of cover material including fabric backings. In aspects, the front and rear portions 304 and 306 include peripheral shapes that conform to the protective case 10. For example, in aspects, the front portion 304 includes an inner surface 305 that conforms with the front surface 32 defined by the one or more sidewalls 22 of the protective case 10 (see FIG. 1B). The inner surface 305 may lie on a display of an electronic device disposed in the cavity 11 defined by the protective case (see FIGS. 1A and 1B). The inner surface 305 includes a plurality of slits 307 (e.g., extending through the cover material such that a fabric backing of the front portion 304 is exposed). The plurality of slits 307 may function as pockets for a user to insert various items (e.g., identification, credit cards, and the like).

As depicted in FIG. 3B, in aspects, the hinge portion 308 includes a non-overlapping portion 310 that extends from a peripheral edge 312 of the front portion 304 and an overlapping portion 314 extending rearward of (e.g., behind) the rear portion 306. In aspects, the overlapping portion 314 is attached to the rear portion 306 at an edge 316 of the overlapping portion 314 such that a remainder of the overlapping portion 314 is movable relative to the rear portion 306. Such mobility facilitates folding the hinge portion 308 over the front portion 304 and placing the wallet accessory in the standing configuration described herein with respect to FIGS. 3E and 3F.

In aspects, the front portion 304, the rear portion 306, and the hinge portion 308 include support panels (not depicted) disposed between the layers of the fabric-backed laminates. The support panels may include sheets or layers of plastic (or other suitable support material) that are attached (e.g., via adhesive or any other suitable attachment method) to fabric backings of the front portion 304 and the rear portion 306 to provide structural rigidity to the wallet accessory 300. In the depicted aspect, the rear portion 306 includes an unsupported portion 320 not including a support panel (e.g., devoid of structural support from a support panel). The unsupported portion 320 includes a boundary that conforms to periphery of the hinge portion 308. In aspects, the unsupported portion 320 of the rear portion 306 provides space for a support panel inserted into the overlapping portion 314 of the hinge portion 308. In aspects, the unsupported portion 320 includes a single layer of fabric (e.g., the same material as the fabric backings of the fabric-backed laminates used to form the rear portion 306). In aspects, the support panel of the overlapping portion 314 does not extend into the non-overlapping portion 310 such that the non-overlapping portion 310 includes only a fabric-backed laminate without structural support to provide flexibility and facilitate folding.

Referring to FIG. 3A, the front and rear portions 304 and 306 may include peripheral regions 322 and 324. In aspects, the peripheral regions 322 and 324 include the fabric-backed laminates that are unsupported by any additional materials. The peripheral regions 322 and 324 may provide cushioning to the electronic device when the wallet accessory 300 is installed on the protective case 10 described herein with respect to FIGS. 1A and 1B. Additionally, the peripheral regions 322 and 324 may include various features to add various functionalities and/or facilitate attachment of other accessories thereto. For example, as depicted in FIG. 3B the peripheral region 324 of the rear portion 306 includes an extension 327 and an attachment strap 328. The extension 327 includes a closing component 330. The closing component 330 may include a magnet, a snap, a clasp, or other suitable component to facilitate retaining the wallet accessory 300 in a closed position. As depicted in FIG. 3D, when the wallet accessory 300 is in a closed configuration, the extension 327 may be flexibly bent around the front portion 304 to position the closing component 330 in proximity to an engagement feature (not depicted), such as a magnet, ferrous material, clip, snap, or the like, disposed at a suitable position on the front portion 304 such that the closing component 330 and the engagement feature maintain the wallet accessory 300 in a closed position. Referring still to FIG. 3D, the attachment strap 328 may be folded back onto itself and secured to the protective case 10 via one of the retention components 302. In such a position, the attachment strap 328 may form an opening 332 through which an accessory 334 (shown as a carbineer) may be inserted. Thus, the flexibility of the peripheral regions 322 and 324 facilitates manipulation of the extension 327 and the attachment strap 328 to perform various functionalities. It should be appreciated that the peripheral regions 322 and 324 may include a number of different features to facilitate attachment of various different accessories to the wallet accessory 300.

With reference to FIGS. 3B and 3C, the rear portion 306 includes a plurality of accessory apertures 326 that are formed (e.g., via die cutting or the like) in the peripheral region 324. In aspects, at least one of the plurality of accessory apertures 326 is situated to overlap with one of the plurality of apertures 30 of the protective case 10 when the wallet accessory 300 is installed on the protective case 10. In aspects, the plurality of accessory apertures 326 are arranged in a manner that corresponds to the arrangement of the plurality of apertures 30 of the protective case 10. In aspects, the plurality of accessory apertures 326 include cross-sectional shapes that correspond to the shapes of the plurality of apertures 30 of the protective case 10. While the plurality of accessory apertures 326 are depicted to correspond in shape and arrangement to the plurality of apertures 30 of the protective case 10, it should be appreciated that aspects are envisioned where the plurality of accessory apertures 326 differ in shape, arrangement, and/or number from the plurality of apertures 30 of the protective case 10.

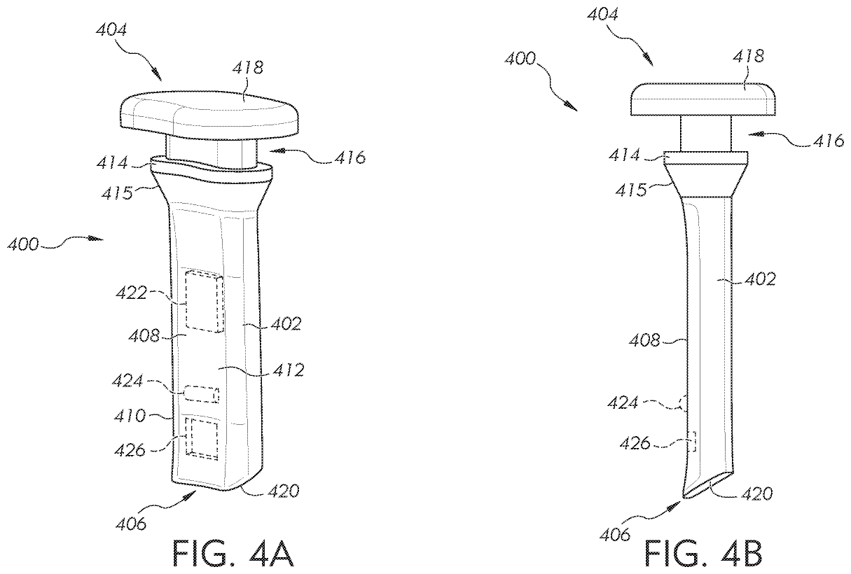

As depicted in FIG. 3C, to install the wallet accessory 300 onto the protective case 10 described herein with respect to FIGS. 1A and 1B, the wallet accessory 300 and the protective case 10 are aligned with one another such that the rear wall 16 of the protective case 10 faces the rear portion 306 and the plurality of accessory apertures 326 are aligned with the plurality of apertures 30 in the protective case 10. That is, the aperture axes 36 of the plurality of apertures 30 may also extend through the plurality of accessory apertures 326 to facilitate insertion of the retention components 302 therethrough. The retention components 302 are depicted as attachment pins having external surfaces that correspond in cross-sectional shape to the plurality of accessory apertures 326 and the plurality of apertures 30 in the protective case 10. An example embodiment of an attachment pin that may be used as the plurality of retention components 302 is described in greater detail herein with respect to FIGS. 4A and 4B.

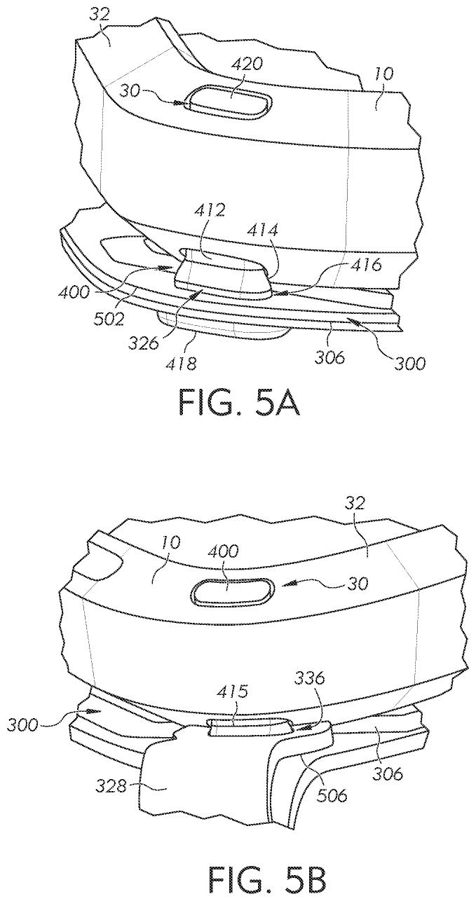

In aspects, as described herein with respect to FIGS. 4A and 4B, the plurality of retention components 302 are inserted through the plurality of accessory apertures 326 and plurality of apertures 30 in the protective case 10 along the plurality of aperture axes 36 until the plurality of retention components 302 are secured within the plurality of apertures 30. In aspects, the plurality of retention components 302 include one or more features (e.g., grooves, channels, and the like) positioned to receive and engage with the rear portion 306 proximate to the plurality of accessory apertures 326 to secure the wallet accessory 300 to the protective case 10. As depicted in FIG. 3C, in aspects, prior to the wallet accessory 300 being attached to the protective case 10, the attachment strap 328 may be folded over itself such that an end aperture 336 therein (see FIG. 3B) overlaps with one of the plurality of accessory apertures 326. In aspects, the portion of the attachment strap 328 including the end aperture 336 may be secured between the rear portion 306 and the protective case 10 via one of the plurality of retention components 302, as described herein with respect to FIGS. 5A and 5B. Folding the attachment strap 328 over itself prior to attachment to the protective case 10 may facilitate forming the opening 332 through which the accessory 334 is attached to the wallet accessory 300 (see FIG. 3D).

Referring now to FIGS. 3E and 3F, two perspective views of the wallet accessory 300 being placed in a stand configuration with the protective case 10 attached thereto (e.g., via the plurality of retention components 302 depicted in FIG. 3C) are shown. To place the wallet accessory 300 into the stand configuration, the hinge portion 308 is folded over itself at the non-overlapping portion 310 such that the overlapping portion 314 extends over the inner surface 305 and is separated from the rear portion 306. As depicted in FIG. 3F, when in the stand configuration, an end 338 of the rear portion 306 contacts the inner surface 305 such that friction between the front and rear portions 304 and 306 maintains the relative positioning thereof. The cavity 11 of the protective case 10 (see FIGS. 1A and 1B) faces outward away from the inner surface 305 to facilitate viewing a display of the electronic device. While the particular configuration depicted in FIGS. 3E and 3F includes the overlapping portion 314 extending approximately perpendicular to the rear portion 306 such that the rear portion 306 extends at an angle of approximately 45° relative to the front portion 304 (e.g., to facilitate a display of an electronic device extending approximately 45° relative to a surface upon which the wallet accessory 300 is disposed), it should be appreciated that the construction of the wallet accessory 300 beneficially facilitates a number of different viewing angles. The degree to which the hinge portion 308 is folded itself may be varied to adjust the location on the inner surface 305 that is contacted by the end 338 of the rear portion 306, thereby changing the viewing angle.

As will be appreciated in view of the standing configuration depicted in FIGS. 3E and 3F, the structural rigidity of the overlapping portion 314 (e.g., provided by a support panel disposed therein) beneficially facilitates maintaining the positioning of the rear portion 306. Moreover, the flexibility of the non-overlapping portion 310 facilitates folding the overlapping portion 314 over the front portion 304 to place the wallet accessory in the standing configuration. As such, the structure of the wallet accessory 300, including both fabric-backed laminates as well as strategically placed support panels, facilitates the versatility of the wallet accessory 300.

Referring now to FIGS. 4A and 4B, an illustrative attachment pin 400 that may be used as a retention component to attach one or more accessories to the protective case 10 described herein with respect to FIGS. 1A and 1B. For example, in aspects, the attachment pin 400 may be used as the retention component 302 to attach the wallet accessory 300 described herein with respect to FIGS. 3A-3F to the protective case 10. It should be understood that the attachment pin 400 depicted in FIGS. 4A and 4B is only one example of a retention component that may be used to attach one or more accessories to the protective case described herein, and that various alternative forms of retention elements, whether they be attachment pins or other forms of retention elements (e.g., attachment straps, wires, magnets, strings, clips, or the like) are contemplated and within the scope of the present disclosure.

Referring to FIGS. 1A, 1B, 4A, and 4B, the attachment pin 400 includes an elongated body 402 that is coupled or couplable to an accessory and is also shaped and sized to be retained within one or more of the apertures 30 of the protective case 10. That is, the attachment pin 400 has a shape, size, and/or various surface features that correspond to a shape, size, and/or surface features of at least one of the apertures 30 of the protective case 10. In some aspects, the attachment pin 400 may have a cross sectional shape that is particularly configured to be inserted and retained within the apertures 30. For example, when traversing the attachment pin 400 from a first end 404 to a second end 406 thereof, the cross sectional shape of the attachment pin 400 may be generally hourglass-like (e.g., to fill the hourglass-like profile of the plurality of apertures 30 depicted in FIG. 2B). That is, a cross section of the attachment pin 400 may be widest at the first end 404 and the second end 406 of the attachment pin 400 and narrowest at a point in between the first end 404 and the second end 406 of the attachment pin 400 (e.g., a midpoint between the first end 404 of the attachment pin 400 and the second end 406 of the attachment pin 400). It should be understood that such an hourglass shape is merely one illustrative example, and other cross sectional shapes (including regular and irregular shapes) are contemplated. For example, the attachment pin 400 may have various other cross sectional geometries, including, without limitation, elliptical cross sections, square cross sections, rectangular cross sections, triangular cross sections, and the like. Further, it should be understood that attachment pin 400 with different cross sectional geometries may be used interchangeably within the apertures 30 of the protective case 10. In some aspects, the attachment pin 400 may each have a consistent cross sectional shape when traversed from the first end 404 of the attachment pin 400 to the second end 406 of the attachment pin 400 (e.g., a cylindrical shape).

In some aspects, the attachment pin 400 may have one or more surface features that allow the attachment pin 400 to be held in place without falling out of the aperture 30 once inserted. For example, as depicted in FIGS. 4A and 4B, the attachment pin may optionally include a positive engagement feature 424 (e.g., a protrusion, bump, knob, projection, post, or similar component) and/or a negative engagement feature 426 (e.g., a bore, hole, receptacle, niche). In aspects, the positive and negative engagement features 424 and 426 may be particularly shaped, sized, configured, and/or oriented for the purposes of engaging with corresponding engagement features of the plurality of apertures of the protective case 10 (see FIGS. 2A and 2B). For example, in aspects, the attachment pin 400 includes an arrangement of one or more of the positive engagement features 424 that corresponds to an arrangement of the negative engagement features 40 of the plurality of apertures 30 of the protective case 10 (see FIG. 2B). In aspects, the attachment pin 400 includes an arrangement of one or more negative engagement features 426 that corresponds to an arrangement of the positive engagement features 42 of the plurality of apertures of the protective case 10 (see FIG. 2B). That is, the attachment pin 400 may include engagement features that are the inverse to engagement features of the plurality of apertures 30 of the protective case 10 to facilitate retention of the attachment pin 400 within the plurality of apertures 30.

In aspects, the attachment pin 400 may have at least one concave surface 408 extending between the first end 404 and the second end 406 thereof, as depicted in FIGS. 4A and 4B. With reference to FIGS. 1A, 1B, 4A, and 4B, in aspects, the concave surface 408 may correspond in shape to convex interior surfaces associated with the plurality of apertures 30 (e.g., disposed proximate to the interior side 24 of the one or more sidewalls 22 of the protective case 10). Such conformity between the concave surface 408 and the convex interior surfaces associated with the plurality of apertures 30 may provide a maximum contact area between the attachment pin 400 and the plurality of apertures, thereby increasing friction and retaining the attachment pin 400 in the plurality of apertures 30 once inserted therein. In aspects, the concave surface 408 includes a greater degree of curvature than the interior surfaces of the plurality of apertures 30 such that ends 410 and 412 of the concave surface 408 press into the interior surfaces of the plurality of apertures 30. Such pressure at the ends 410 and 412 may retain the attachment pin 400 in the plurality of apertures 30 when inserted therein.

In aspects, the attachment pin 400 may include one or more recesses, grooves, indentations, protrusions, flanges, detents, threads, and/or the like on one or more surfaces of the attachment pin 400, which, when contacted or otherwise engaged with the internal walls of the aperture 30, cause the attachment pin 400 to be retained within corresponding recesses, grooves, indentations, protrusions, flanges, detents, threads, and/or the like within the aperture 30, as described herein. In still another example, the elongated body 402 of the attachment pin 400 may be particularly shaped in such a manner that causes the attachment pin 400 to be retained within the aperture 30, such as an hourglass shape or the like. In still further aspects, the attachment pin 400 may have one or more press fit features that allow the attachment pin 400 to expand and contract when inserted and retained within an aperture 30. In some aspects, the attachment pin 400 may be formed of a material or have various surface features for frictional engagement of the attachment pin 400 with the aperture 30 when the attachment pin 400 is inserted.

In aspects, the attachment pin 400 includes one or more magnets 422 disposed therein. That is, the body of the attachment pin 400 may be formed with one or more receptacles to facilitate insertion of the one or more magnets 422. In aspects, the one or more magnets 422 provide magnetic forces that can be used to facilitate placement of the attachment pin 400 within the apertures 30 and/or for retaining the attachment pin 400 within the apertures 30 after insertion. In aspects, the one or more magnets 422 may be placed in the attachment pin 420 to align with the magnet 38 disposed proximate to one of the plurality of apertures 30 (see FIG. 2B) such that the magnetic attraction therebetween retains the attachment pin 400 in the aperture 30. In some aspects, the material of the body of the attachment pin 400 may be formed of a magnetic material. That is, the entire body of the attachment pin 400 may be formed of a magnetic material or a portion of the body of the pin is formed of a magnetic material. Examples of suitable magnetic materials (e.g., various ferromagnetic materials) should generally be understood. In aspects, the body of the attachment pin 400 is coated with a suitable magnetic material.

As shown in FIGS. 4A and 4B, the attachment pin 400 also includes an accessory retention flange 414 disposed toward one of the ends of the elongated body 402. In the depicted aspect, the accessory retention flange 414 is disposed proximate to the first end 404 of the elongated body 402 and includes a slanted surface 415 extending outward from the elongated body 402. The slanted surface 415 may facilitate insertion of the attachment pin 400 into the plurality of apertures 30 of the protective case 10 (see FIGS. 1A and 1B) or accessories by avoiding abrupt changes in cross-sectional area. The slanted surface 415 ends a distance from a head portion 418 of the attachment pin 400 to form a retention cavity 416 extending between the accessory retention flange 414 and the head portion 418. In aspects, the retention cavity 416 includes a size that conforms with a portion of an accessory that the attachment pin 400 is used to attach to the protective case 10 (see FIGS. 1A and 1B). For example, as described herein with respect to FIGS. 5A and 5B, a portion of the wallet accessory 300 described herein with respect to FIGS. 3A-3F may fit within the retention cavity 416 to secure the wallet accessory 300 to the protective case.

In aspects, the second end 406 of the attachment pin 400 includes a surface designed to conform to an exterior surface of a protective case that the attachment pin 400 is used to attach accessories to. For example, with reference to FIGS. 1B, 4A, and 4B, the second end 406 of the attachment pin 400 includes a slanted surface 415 that conforms in shape to the front surface 32 of the protective case 10. For example, in aspects, the attachment pin 400 includes a length that corresponds to a distance between the front surface 32 and the rear wall 16 of the protective case 10 along the aperture axes 36. In such aspects, the slanted surface 415 substantially conforms in shape to the ends of the plurality of apertures 30 such that, when the attachment pin 400 is inserted into one of the plurality of apertures 30, the front surface 32 and the slanted surface 415 form a substantially continuous surface. Such a construction may improve the appearance of the protective case 10 and beneficially prevent the attachment pin from unnecessarily protruding outward from the protective case 10. In aspects, both the first end 404 and the second end 406 of the attachment pin 400 include surfaces that conform with the shape of an exterior surface of the protective case 10.

It should be understood that the attachment pin 400 depicted in FIGS. 4A-4B is merely an illustrative example. In other aspects, the attachment pin 400 may have a different size or shape, may be a different type of pin (e.g., but not limited to, a clevis pin, a drop nose pin, a cotter pin, a linchpin, a pin incorporating an r-clip or the like, a split pin, a spring pin, a tapered pin, or the like), or may be an alternative component (e.g., not a pin). Various types of retention components are envisioned, and the present disclosure is not limited to any particular type of retention component. Illustrative examples of retention components other than a pin include, but are not limited to, a post (for example, but not limited to, a binding post), a nail, a dowel, a stud, a peg, a ribbed structure, a clamp (including, but not limited to a c shaped clamp), a clip (for example, but not limited to, a c-clip, a hairpin clip, a terry clip, a circlip or the like), a buckle (for example, but not limited to, a buckle having a prong that extends through the aperture 30 and a frame that engages the prong on one end of the aperture), a clasp, a strap, a band, a screw, a bolt, a threaded rod, a split ring, a button, a tie (for example, but not limited to, a cable tie, a twist tie, or the like), a clip snap fastener, a snap, a staple, a securing device that incorporates a pin and a clutch, a particularly formed magnet, and/or the like may be used instead of a pin for insertion (including partial insertion) within the aperture 30 (FIGS. 1A and 1B) and retention of the accessory to the protective case 10 (FIGS. 1A and 1B) according to the aspects described herein.

While the example depicted in FIGS. 4A-4B includes an elongated body 402 extending in a straight line, it should be understood that attachment pins following non-linear profiles are also contemplated and within the scope of the present disclosure. For example, in aspects, attachment pins for insertion into the plurality of apertures 30 may curve between ends thereof (e.g., and include a spherical curvature, a freeform curvature, or other suitable curvature). In aspects, attachment pins may include a plurality of linear portions that are attached to one another via bend sections such that the attachment pins are zig-zag shaped. In aspects, attachment pins may follow a shape of the plurality of aperture axes 36 of the plurality of apertures 30 (see FIG. 1B) to facilitate the attachment pins extending through the plurality of apertures 30. In aspects, the attachment pins may include a multi-piece construction where different pieces of the attachment pins are inserted into different ends of the plurality of apertures 30 to facilitate the attachment pins extending through such apertures including bends.

In some aspects, a device that creates a vacuum seal within the aperture 30 (e.g., by covering both openings of the aperture 30 and evacuating the air therebetween) is also envisioned without departing from the scope of the present disclosure. Such a vacuum seal device may provide the apertures 30 with a dual purpose in that the apertures secure an accessory to the vacuum seal device (e.g., on an exterior of the vacuum seal device) while also maintaining a void within the apertures 30 that can be used for impact absorption (e.g., absorb impacts caused from dropping or the like). In some aspects, a clip or similar device that incorporates one or more teeth that are partially inserted within the apertures 30 Any other means of retaining the accessory via mounting about or through one or more of the apertures 30 are contemplated and included within the scope of the present disclosure.

FIGS. 5A and 5B depict close-up views of an example where a plurality of the attachment pins 400 described herein with respect to FIGS. 4A and 4B are used to attach the wallet accessory 300 described herein with respect to FIGS. 3A-3F to the protective case 10 described with respect to FIGS. 1A and 1B. FIG. 5A depicts a close-up view of the attachment pin 400 being inserted through first ones of the pluralities of accessory apertures 326 and apertures 30 of the protective case 10 to attach a first portion of the wallet accessory 300 to the protective case 10 (e.g., corresponding to the area 500 depicted in FIG. 3D). As depicted in FIG. 5A, when the attachment pin 400 is inserted in a pairing of one of the plurality of accessory apertures 326 and one of the plurality of apertures 30, the elongated body 402 extends through the aperture 30 in the protective case 10. The accessory retention flange 414 is disposed outside of the aperture 30 and extends between the protective case 10 and the wallet accessory 300. A portion 502 of the wallet accessory 300 surrounding the accessory aperture 326 is compressed in the retention cavity 416 between the accessory retention flange 414 and the head portion 418. Such compression of the portion 502 beneficially results in the wallet accessory 300 being secured to the protective case 10. As shown, the attachment pin 400 is retained within the aperture 30 such that the slanted surface 415 conforms with the front surface 32 of the protective case 10.

FIG. 5B depicts a close-up view of the attachment pin being inserted through second ones of the pluralities of accessory apertures 326 (not depicted in FIG. 5B, see FIGS. 3A-3F) and apertures 30 of the protective case 10 to attach a second portion of the wallet accessory 300 to the protective case 10 (e.g., corresponding to the area 504 depicted in FIG. 3D). As depicted in FIG. 5B, prior to the attachment pin 400 being inserted in the aperture 30 of the protective case 10, the attachment strap 328 is folded over itself such that the end aperture 336 overlaps the aperture 30 (and one of the plurality of accessory apertures 326, not depicted in FIG. 5B). The attachment pin 400 extends through the rear portion 306 of the wallet accessory 300 (e.g., via one of the plurality of accessory apertures 326, see FIG. 3B) and is retained in the aperture 30 of the protective case 10 in a similar manner as that described with respect to FIG. 5A. A portion 506 of the wallet accessory 300 may be compressed in the retention cavity 416 extending between the accessory retention flange 414 and the head portion 418, see FIG. 4A).

As shown in FIG. 5B, the attachment strap 328 is disposed between the rear portion 306 and the protective case 10, such that an interior surface of the end aperture 336 contacts the slanted surface 415. In aspects, the slanted surface 415 includes an exterior surface that conforms to an interior surface of the end aperture 336 such that the attachment strap 328 is retained between the protective case 10 and the rear portion 306 of the wallet accessory 300. As demonstrated in the preceding example, the shape of the attachment pin 400 beneficially facilitates attachment of different portions of the wallet accessory 300 to the protective case 10 having different structures. While FIGS. 5A-5B depict a particular example where the attachment pin 400 of FIGS. 4A and 4B is used to secure the wallet accessory 300 to the protective case 10, it should be understood that alternative retention components (e.g., clips, straps, strings, loops, multi-portion retention pieces, or other suitable components) may be used to secure the wallet accessory 300 to the protective case 10 via the plurality of apertures 30.

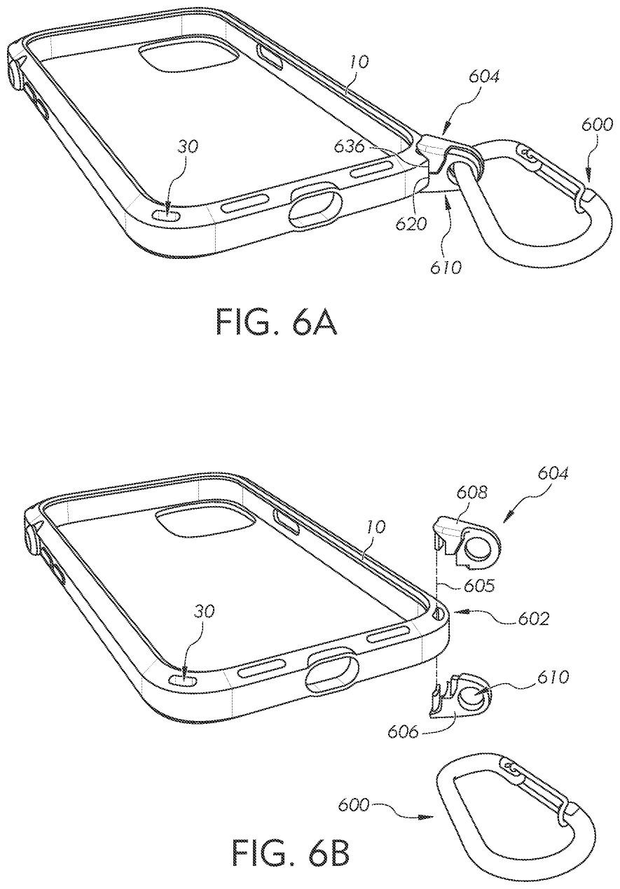

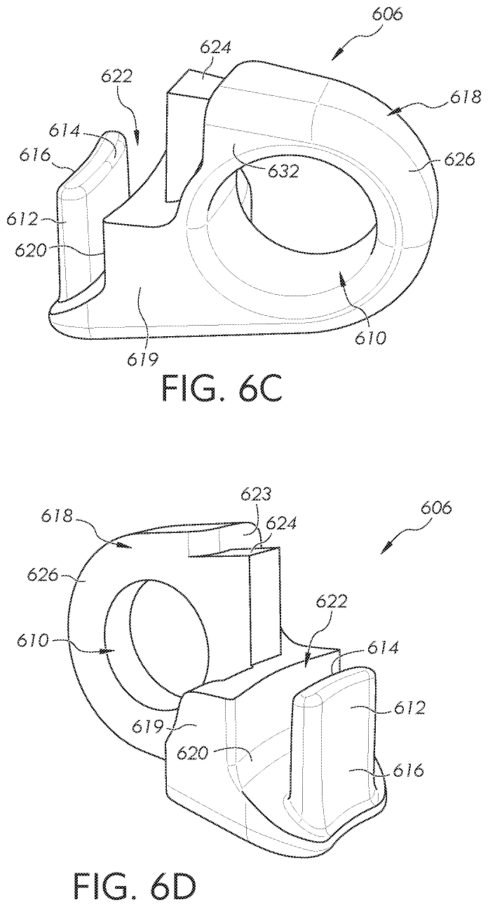

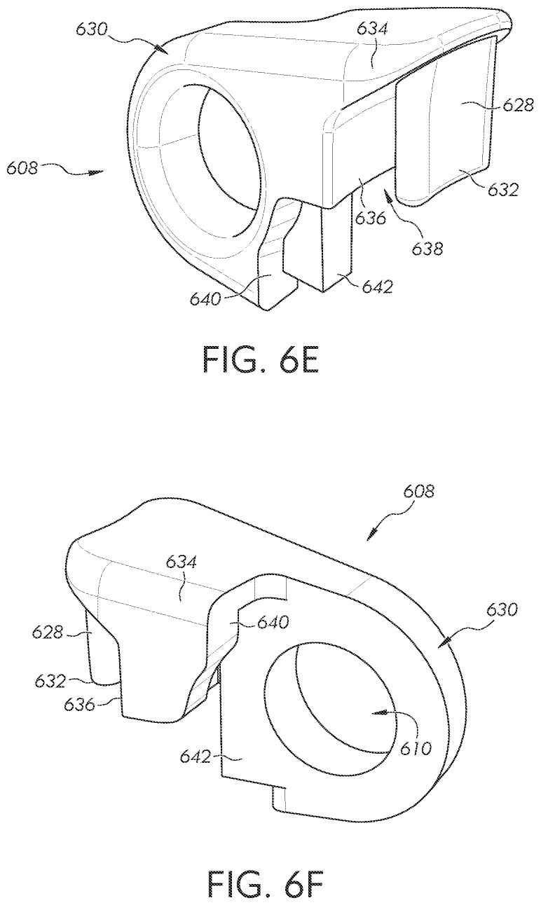

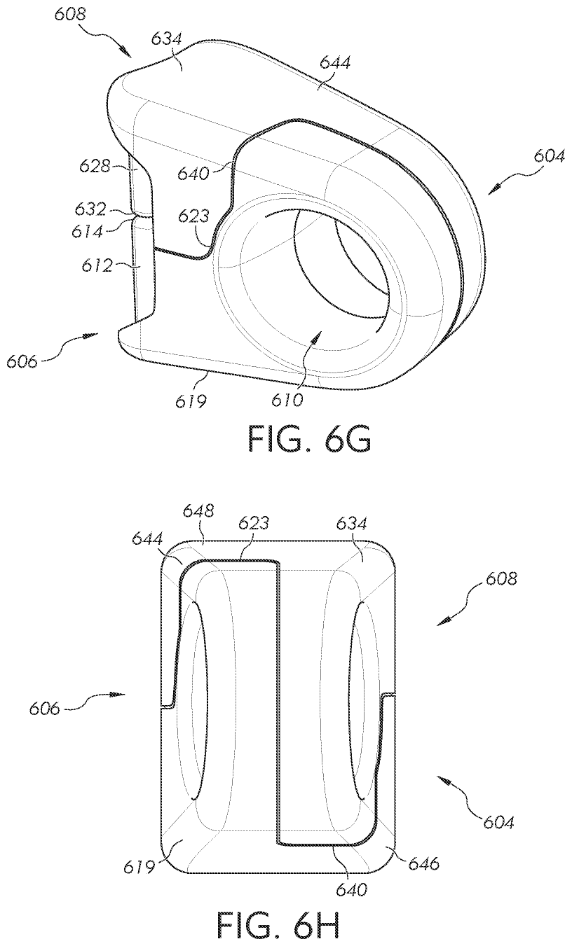

FIGS. 6A-6H depict various aspects of another example where an accessory 600, shown as a carabiner, is attached to the protective case 10 described herein with respect to FIGS. 1A and 1B via an aperture 602 of the plurality of apertures 30. With reference to FIGS. 6A and 6B, the accessory 600 is attached to the protective case 10 via a multi-portion retention piece 604. As shown in FIG. 6B, the multi-portion retention piece 604 includes a lower portion 606 and an upper portion 608 that are each inserted into the aperture 602 to form an connection opening 610 permitting attachment of the accessory 600 to the protective case 10. An assembly axis 605 extends through the aperture 602 and portions of the lower portion 606 and the upper portion 608. In aspects, to assemble the multi-portion retention piece 604, the lower portion 606 and the upper portion 608 are aligned with one another such that portions thereof are aligned with the apertures 602. The lower portion 606 and upper portion 608 may then be inserted (e.g., either successively or simultaneously) into the aperture 602 and engage with one another therein such that the multi-portion retention piece 604 is in the configuration depicted in FIG. 6A. In aspects, the lower portion 606 is inserted into the first end of the aperture 602 and the upper portion 608 is inserted into a second end of the aperture 602. In aspects, the lower portion 606 and the upper portion 608 connect and/or face one another within the aperture 602 to form the multi-portion retention piece 604 including the connection opening 610. In aspects, the upper portion 608 may be coupled to the lower portion 606 by a biasing member (not shown). The biasing member may be a rotational spring, such that the lower portion 606 and the upper portion 608 are rotatably coupled together and the biasing member forces the lower portion 606 and the upper portion 608 together. More specifically, the biasing member may bias the lower portion 606 relative to the upper portion 608 such that the portion of each of the lower portion 606 and the upper portion 608 that are inserted into the aperture 602 are biased toward each other and clamp the multi-portion retention piece 604 to the protective case 10. In aspects, the upper portion 608 and the lower portion 606 may be rotatably coupled together without a biasing member. In aspects, the upper portion 608 and the lower portion 606 may be movably coupled together, such that the upper portion 608 moves toward and/or away from the lower portion 606.

Referring now to FIGS. 6C and 6D, various aspects of the lower portion 606 of the multi-portion retention piece 604 will now be described in greater detail. The lower portion 606 includes an insertion portion 612 and an opening portion 618. The insertion portion 612 is structured to be inserted into the aperture 602 (e.g., or one or more of the plurality of apertures 30, see FIGS. 6A and 6B). In aspects, the insertion portion 612 includes a length such that, when the insertion portion 612 is fully inserted into the aperture 602 (see FIGS. 6A and 6B), an end 614 of the insertion portion 612 is disposed between ends of the aperture 602. In aspects, the insertion portion 612 includes an exterior surface shape that corresponds to a cross-sectional profile of the aperture 602 (see FIGS. 6A and 6B) to facilitate retention of the insertion portion 612 within the aperture 602. For example, in aspects, the insertion portion 612 includes a concave surface 616 that functions similarly to the concave surface 408 of the attachment pin 400 described herein with respect to FIGS. 4A and 4B.

The lower portion 606 also includes a body 619 extending between the insertion portion 612 and the opening portion 618. The body 619 includes a contacting surface 620 extending substantially parallel to the insertion portion 612, but offset from the insertion portion 612 to form a protective case gap 622 extending between the insertion portion 612 and the body 619. In aspects, the contacting surface 620 is designed to conform to an exterior surface of the protective case 10 such that the contacting surface 620 lies on the protective case 10 without significant air gaps extending therebetween to facilitate stability of the multi-portion retention piece 604 (see FIGS. 6A and 6B). In aspects, the protective case gap 622 is sized to correspond to the dimensions of the portion of the protective case 10 extending between the aperture 602 and an exterior surface of the protective case 10, such that the protective case 10 is secured within the protective case gap 622 and the lower portion 606 is secured to the protective case 10 when the insertion portion 612 is inserted in the aperture 602 (see FIGS. 6A and 6B).

Referring still to FIGS. 6C and 6D, the opening portion 618 includes a mating surface 623 and a mating structure 624 extending from the mating surface 623. In aspects, the mating surface 623 is structured to correspond to a corresponding mating surface on the upper portion 608 of the multi-portion retention piece 604 (see FIGS. 6A and 6B) such that, when both the upper portion 608 and the lower portion 606 are inserted in the aperture 602, the multi-portion retention piece 604 forms a substantially continuous body. The opening portion 618 also includes a substantially circular body comprising an opening to form a portion of the connection opening 610 (see FIGS. 6A and 6B).

Referring now to FIGS. 6E and 6F, various aspects of the upper portion 608 of the multi-portion retention piece 604 of FIGS. 6A and 6B are depicted in greater detail. The upper portion 608 includes an insertion portion 628 and an opening portion 630. The insertion portion 628 is structured to be inserted into the aperture 602 (see FIGS. 6A and 6B) of the protective case 10. In aspects, the insertion portion 628 includes a length such that, when the insertion portion 628 is fully inserted into the aperture 602, an end 632 of the insertion portion 628 is disposed in the aperture 602 (see FIGS. 6A and 6B). In aspects, the end 632 of the insertion portion 628 contacts the end 614 of the insertion portion 612 of the lower portion 606 (see FIGS. 6C and 6D) when both the upper portion 608 and the lower portion 606 are fully inserted in the aperture 602 (see FIGS. 6A and 6B). With reference to FIGS. 6C-6F, in aspects, the ends 614 and 632 include one or more engagement features (e.g., magnets, hole and pin combination, clip, clasp, or other suitable engagement feature) that interact with one another to secure the insertion portions 612 and 628 to one another within aperture 602 (see FIGS. 6A and 6B). In aspects, one of the ends 614 and 632 is inserted into another one of the ends 614 and 632 to facilitate securing the upper portion 608 and the lower portion 606 within the aperture 602 (see FIGS. 6A and 6B).

As depicted in FIGS. 6E and 6F, the upper portion 608 includes a body 634 defining a contacting surface 636 that is offset from the insertion portion 628 to form a protective case gap 638. In aspects, a portion of the protective case 10 extending between the aperture 602 and an exterior surface thereof (see FIGS. 6A and 6B) is inserted in the protective case gap 638 to secure the upper portion 608 to the protective case 10. The opening portion 630 includes a mating surface 640 and a mating structure 642 extending from the mating surface 640. In aspects, the mating surface 640 is structured to conform to the mating surface 623 of the lower portion 606 (see FIGS. 6C and 6D) such that the lower portion 606 and the upper portion 608 combine to form a substantially continuous body when inserted in the aperture 602 (see FIGS. 6A and 6B). The mating structure 642 is centrally disposed within the upper portion 608. In aspects, the mating structure 642 contacts and is situated adjacent to (but offset from) the mating structure 624 of the lower portion 606 (see FIGS. 6C and 6D) when both the insertion portions 612 and 628 are inserted in the aperture 602 (see FIGS. 6A and 6B).

FIGS. 6G and 6H depict the multi-portion retention piece 604 when the ends 614 and 632 of the insertion portions 612 and 628 of the lower portion 606 and the upper portion 608 are aligned and pressed against one another. In aspects, FIGS. 6G and 6H depict a state of the multi-portion retention piece 604 when the insertion portions 612 and 628 are fully inserted into the aperture 602 of the protective case 10 (see FIGS. 6A and 6B). As depicted, the bodies 619 and 634 of the lower portion 606 and the upper portion include complementary shapes to form a substantially continuous body 644. The mating surface 623 of the lower portion 606 contacts the mating surface 640 of the upper portion 608 to form the substantially continuous body 644. As depicted in FIG. 6H, the body 619 of the lower portion 606 includes an underlying portion 646 that underlies the body 634 of the upper portion 608. The body 634 of the upper portion 608 includes an overlying portion 648 that overlies the body 619 of the lower portion 606. In aspects, the underlying portion 646 and the overlying portion 648 are disposed at different locations in the substantially continuous body 644 (e.g., at different distances from the insertion portions 612 and 628 (see FIG. 6G). Such a configuration beneficially prevents the lower portion 606 and the upper portion 608 from twisting relative to one another and maintains the shape of the substantially continuous body 644 when installed on the protective case 10.

Referring to FIGS. 6A and 6B, when both the lower and upper portions 606 and 608 are inserted in the aperture 602, the contacting surfaces 620 and 636 thereof (see FIGS. 6C-6E) contact the protective case 10 to secure the multi-portion retention piece 604 thereto. As a result, the accessory 600 may rotate within the connection opening 610 and be manipulated, without causing the relative orientation of the multi-portion retention piece 604 to change. The contact area between the contacting surfaces 620 and 636 and protective case 10 beneficially results in the multi-portion retention piece 604 being securely positioned and allow a plurality of different accessories to be attached to the protective case 10 at the connection opening 610. The multi-piece construction of the multi-portion retention piece 604 facilitates easy installation and removal thereof via the plurality of apertures 30, while still providing the ability to securely attach a plurality of different accessories to the protective case 10.

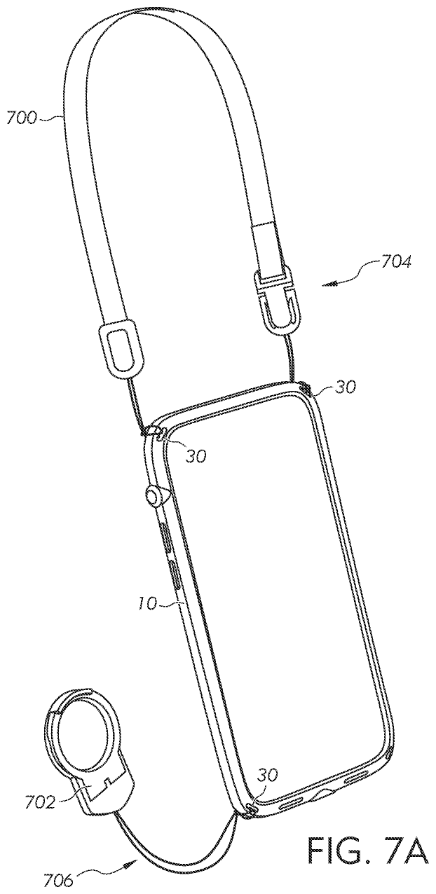

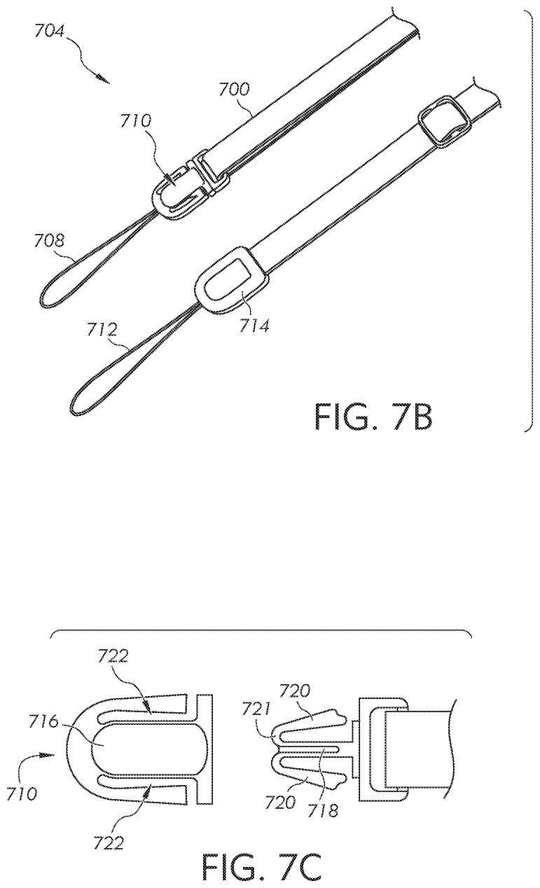

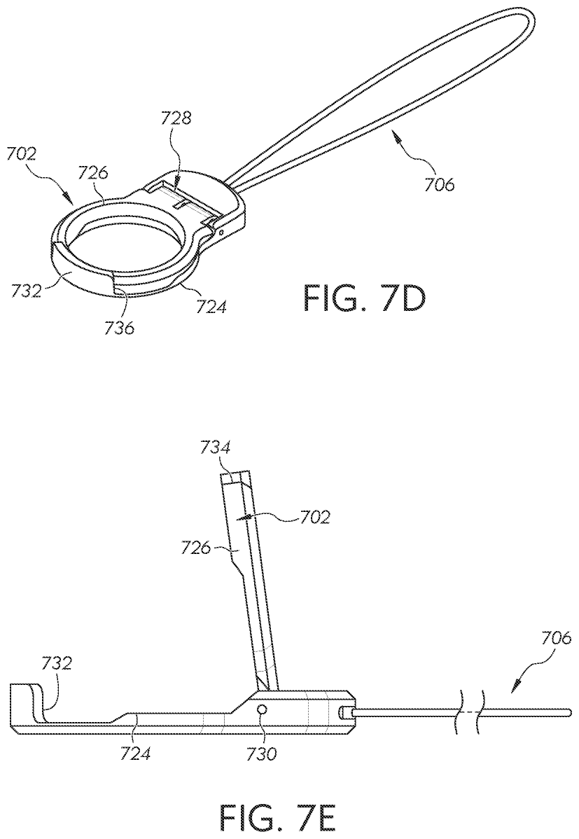

A number of different retention elements may be used to attach accessories to the protective case 10 described herein with respect to FIGS. 1A and 1B. For example, FIGS. 7A-7E depict various aspects of a first accessory 700 being attached to the protective case 10 via a first set of the plurality of apertures 30 and a second accessory 702 being attached to the protective case 10 via a second set of the plurality of apertures 30. FIG. 7A depicts both the first accessory 700 and the second accessory 702 being attached to the protective case 10. The first accessory 700 is depicted as a strap extending in an arc-like shape between two of the plurality of apertures 30. For example, the strap may function as a shoulder strap allowing a user to carry the electronic device disposed in the protective case 10. The second accessory 702 is depicted as a stand ring. As described herein, the stand ring may include a plurality of portions that are movable relative to each other so as to be placed in a stand configuration for placing the protective case 10 in a viewing configuration. Each of the first accessory 700 and the second accessory 702, as well as the way that the first and second accessories 700 and 702 are attached to the protective case via the plurality of apertures 30, will now be described in greater detail.

Referring still to FIG. 7A, the first accessory 700 is attached to a pair of the plurality of apertures 30 via a first retention component 704, while the second accessory 702 is attached to another one of the plurality of apertures 30 via a second retention component 706. While, in the depicted example, non-overlapping sets of the plurality of apertures 30 are used to attach different accessories to the protective case 10, it should be understood that aspects are also envisioned where a plurality of accessories are attached to the protective case 10 using the same aperture or set of apertures.

FIGS. 7B and 7C depict the first retention component 704 in greater detail. The first retention component 704 includes a first attachment loop 708 attached to a first end of the first accessory 700 via a clip assembly 710 and a second attachment loop 712 attached to a second end of the first accessory 700 via an attachment member 714. In aspects, the first and second attachment loops 708 and 712 are attached to the protective case 10 by initially routing the first and second attachment loops 708 and 712 through different ones of the plurality of apertures 30 and then routing the first accessory 700 through both of the first and second attachment loops 708 and 712 (e.g., by disassembling the clip assembly 710). In aspects, the attachment member 714 is a plastic housing to which both the second attachment loop 712 and the first accessory 700 are attached (e.g., via adhesive or other suitable attachment method). The attachment member 714 may include an opening through which the second attachment loop 712 extends to render the second attachment loop 712 accessible.

As depicted in FIG. 7C, the clip assembly 710 includes a housing 716 and a clip portion 718. The clip portion 718 includes elastic arms 720 extending outward from an insertion end 721 of the clip portion 718. As the clip portion 718 is inserted into the housing 716, the elastic arms 720 are compressed inward until ends of the elastic arms 720 reach openings in the housing 716, at which point the elastic arms 720 extend outward and contact inner surfaces of the openings 722 to secure the clip portion 718 in the housing 716. It should be understood that the depicted clip assembly 710 is only one example and a variety of other clip assemblies (e.g., magnetic-based clips, adhesive-based attachment mechanisms, or the like) are also contemplated and within the scope of the present disclosure.

With reference to FIG. 7A, in aspects, to attach the first accessory 700 to the protective case 10, the clip assembly 710 may be disassembled (e.g., the clip portion 718 may be removed from the housing 716 by pressing the elastic arms 720 inward and pulling the clip portion 718 out of the housing 716) and the first attachment loop 708 may be routed through a first one of the plurality of apertures 30. The housing 716 may be attached to the protective case 10 by routing the housing through the first attachment loop 708. The remainder of the first accessory 700 (e.g., the strap), may be attached to the protective case 10 by routing the second attachment loop 712 through a second one of the plurality of apertures 30 and then routing the strap and attachment member 714 through the second attachment loop 712. Finally, the clip portion 718 may be inserted into the housing 716 to fully secure the first accessory 700 to the protective case 10.

Referring now to FIGS. 7D and 7E, the second accessory 702 and second retention component 706 are depicted in greater detail. As depicted, the second retention component 706 is an attachment loop attached to the second accessory 702. The second retention component 706 may be inserted in any one of the plurality of apertures 30 to facilitate attachment of the second accessory 702 to the protective case 10 (see FIG. 7A). The second accessory 702 is depicted as a ring stand including a base 724 and a support portion 726 that are attached to one another via a rotatable connection 728 (e.g., a hinge, foldable element, magnetic attachment, flexible element, or other suitable connection). As depicted in FIG. 7E, the rotatable connection 728 facilitates pivoting the support portion 726 relative to the base 724 about a pivot axis 730 to facilitate placing the second accessory 702 in a plurality of different configurations. FIG. 7D depicts the second accessory 702 in a closed configuration. As shown, the base 724 includes an end extension 732 that fits into an opening 736 formed in the support portion 726. In aspects, at least one of the base 724 and the support portion 726 includes an engagement feature (e.g., a magnet, groove, clasp, or the like) that engages with the other one of the base 724 and the support portion 726 to secure the second accessory 702 in the position depicted in FIG. 7D. In aspects, a user may rotate the support portion 726 relative to the base 724 to place the second accessory 702 in a stand configuration depicted in FIG. 7E. While in the stand configuration, the protective case 10 (see FIG. 7A) may rest on the end extension 732 and an end surface 734 of the support portion 726, such that the cavity 11 of the protective case 10 faces upward from a surface upon which the second accessory 702 is disposed (see FIGS. 1A and 1B). Such a configuration beneficially places an electronic device at a convenient viewing angle.

It should be appreciated that the accessories described herein (e.g., the wallet accessory 300 described with respect to FIGS. 3A-3F, the accessory 600 depicted in FIGS. 6A and 6B, and the first and second accessories 700 and 702 depicted in FIG. 7A) that are attached to the protective case 10 are only examples of accessories that may be attached to the protective case 10 via the plurality of apertures 30. A plurality of other accessories are contemplated and within the scope of the present disclosure. In aspects, for example, a key ring accessory may be attached to the protective case 10 via one or more of the plurality of apertures 30. In an example, a key ring accessory may include an attachment loop (e.g., similar to the second retention component 706 described herein with respect to FIG. 7A) that may be routed through one of the plurality of apertures 30. In aspects, other retention components (e.g., the multi-portion retention piece 604 described herein with respect to FIGS. 6A-6H, the attachment pin 400 described herein with respect to FIGS. 4A and 4B, or other suitable retention component) may be used to attach such a key ring accessory to the protective case 10 via the plurality of apertures 30. In aspects, an ornamental trinket accessory may be attached to the protective case 10 via the plurality of apertures 30 via a similar set of retention components as described herein with respect to the key ring accessory.

In aspects, a clip accessory may be attached to the protective case 10 via the plurality of apertures 30. In an example, the clip accessory may include a panel of material extending over the rear wall 16 (e.g., similar to the rear portion 306 of the wallet accessory 300 described herein with respect to FIGS. 3A-3F) that is attached to the protective case 10 via the plurality of apertures 30 (e.g., via one or more of the attachment pins 400 described herein with respect to FIGS. 4A and 4B). A clip member may extend from the panel of material and be configured to apply pressure to an item (e.g., a user's clothing) inserted between the clip member and the panel such that the protective case 10 is supported on the item via the clip member. In another example, an external clip member (e.g., movable relative to the body 12, see FIG. 1A) may be attached to one of the plurality of apertures 30 via another retention component (e.g., an attachment loop, a multi-portion retention piece such as the multi-portion retention piece 604 described herein with respect to FIGS. 6A-6H).

In aspects, one or more supplemental power accessories may be attached to the protective case 10 via the plurality of apertures 30. In aspects, for example, a supplemental battery pack may be attached to the protective case via the plurality of apertures 30. In aspects, the supplemental battery pack includes a housing or attachment structure through which a retention component may extend to attach the supplemental battery pack to the protective case 10. In aspects, the supplemental battery pack may include a housing that extends over the rear wall 16 and is secured to the protective case 10 via the plurality of apertures 30 (e.g., similar to the rear portion 306 of the wallet accessory 300 described herein with respect to FIGS. 3A-3F). The supplemental battery pack may be positioned within the housing such that, when the housing is attached to the protective case 10, the supplemental battery pack is aligned with a receiver coil of an electronic device disposed in the protective case 10 to facilitate wireless charging thereof. In aspects, the supplemental battery pack may be movably attached to the protective case via the plurality of apertures 30 (e.g., via an attachment loop or other suitable retention component) and the supplemental battery pack may include a magnet or other suitable attachment mechanism (e.g., a clip, a post, or the like) that engages with the protective case 10 to position the supplemental battery pack on or in close proximity to the receiver coil to facilitate wireless charging.

In aspects, a solar panel may be coupled to the protective case 10 via the plurality of apertures 30. The solar panel may also facilitate wireless charging of an electronic device disposed in the protective case 10 by being placed in alignment with a receiver coil of the electronic device. In aspects, the solar panel may be attached to the protective case via a housing and a suitable set of retention components extending through both the housing and the plurality of apertures 30. The housing may be constructed to place an induction coil coupled to the solar panel in close proximity to a receiver coil of the electronic device to facilitate wireless charging. In aspects, a solar panel or supplemental battery pack may be coupled to another accessory (e.g., the wallet accessory 300 described herein with respect to FIGS. 3A-3F) that is attached to the protective case 10 via the plurality of apertures 30.

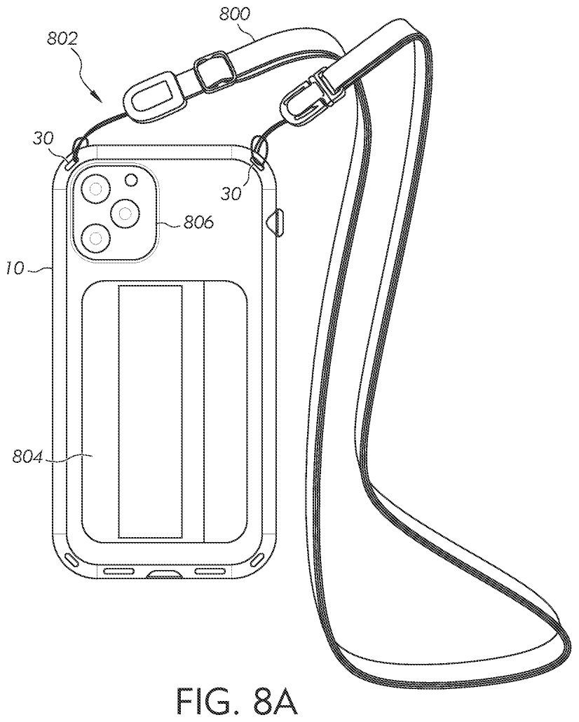

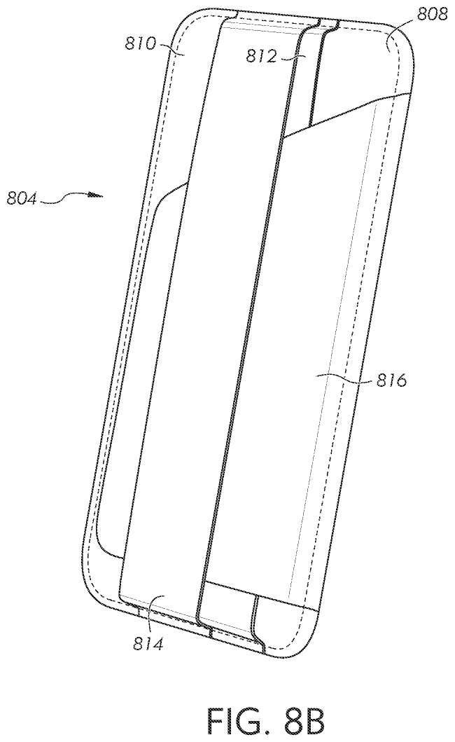

FIG. 8A depicts a first accessory 800 being attached to the protective case 10 via a set of the plurality of apertures 30 using a first retention element 802. A second accessory 804 is also attached to a rear surface 806 of the protective case 10. In the depicted example, the first accessory 800 and first retention element 802 correspond to the first accessory 700 and the first retention component 704 described herein with respect to FIGS. 7A-7C. It should be understood that the second accessory 804 may be used in conjunction with any accessory attachable to the protective case 10 via any of the plurality of apertures 30 and the depicted first accessory 800 is only an example.

In aspects, the second accessory 804 is attached to the rear surface 806 using any one of a variety of suitable attachment methods. For example, in aspects, the second accessory 804 is attached to the rear surface 806 via an adhesive layer disposed on a rear surface of the second accessory 804 and/or the rear surface 806 of the protective case 10. In aspects, the second accessory 804 is magnetically attached to the rear surface 806 via one or more magnets disposed in the protective case 10. In aspects, the second accessory 804 is magnetically attached to the rear surface 806 via magnets not contained in the protective case 10, but rather via magnets of an electronic device disposed in the cavity of the protective case 10 (see FIGS. 1A and 1B). In aspects, the second accessory 804 may be moved relative to the protective case 10 to be placed at different locations on the rear surface 806. In aspects, the second accessory 804 is attached to the protective case 10 at a location other than the rear surface 806 (e.g., via one of the plurality of apertures 30, via a magnet or other attachment element disposed in the one or more sidewalls 22 depicted in FIGS. 1A and 1B).

FIG. 8B depicts an illustrative example of the second accessory 804 of FIG. 8A. As shown, the second accessory 804 is a wallet accessory. In aspects, the second accessory 804 is a multi-layer structure comprising a base layer 808 and a protective layer 810 disposed on the base layer 808. In aspects, the base layer 808 includes a magnet to facilitate attachment of the second accessory 804 to the protective case 10 (see FIG. 8A). In aspects, the base layer 808 and the protective layer 810 are constructed of fabric-backed laminates similar in structure to the front portion 304 and the rear portion 306 of the wallet accessory 300 described herein with respect to FIGS. 3A-3F. As show, the protective layer 810 ends along a surface of the base layer 808 to form one or more pockets 812 for a user to hold various items (e.g. identification or credit cards) between the base layer 808 and the protective layer 810. In aspects, the second accessory 804 includes a strap 814 extending between ends thereof. In aspects, the strap 814 is constructed from a suitable flexible material to allow a user to insert his or her hand therethrough to facilitate holding the protective case 10 (see FIG. 8A). In aspects, the second accessory 804 includes a flap 816 that may be routed through the strap 814 to conceal the items disposed in the one or more pockets 812.

In aspects, the second accessory 804 may be used as a stand to place the protective case 10 in a viewing configuration. For example, in aspects, the base layer 808 includes multiple portions that are movable relative to one another (e.g., foldable) and contact one another (e.g., in a manner similar to the wallet accessory 300 described herein with respect to FIGS. 3A-3E) to maintain the protective case 10 in a viewing configuration. In aspects, the flap 816 may be positioned within the strap 814 such that second accessory 804 functions as a stand. In aspects, the flap 816 may include a plurality of foldable segments to facilitate a flexible viewing angle of the protective case 10.

In aspects, a plurality of different accessories may be attached to the rear surface 806 of the protective case 10 via the attachment mechanisms described herein with respect to the second accessory 804. For example, in aspects, such additional accessories may include a stand accessory (e.g., that is different from the second accessory 804, such as the second accessory 702 described herein with respect to FIG. 7A), a key ring accessory (e.g., a strap may be magnetically attached to the rear surface 806 and may include a key ring or other accessory structure at an end thereof), a clip accessory (e.g., instead of the one or more pockets 812 and the flap 816, one or more clips may extend from the base layer 808, with the one or clips being configured to apply pressure to an item, such as clothing, disposed between the base layer 808 and the one or more clips), a carabiner accessory, a trinket accessory, and a lanyard accessory.

In aspects, supplemental power accessories, such as a supplemental battery pack and/or a solar panel may be attached to the protective case 10 via the rear surface 806. For example, in aspects, a solar panel may be magnetically attached to the rear surface 806 via a magnet disposed in the electronic device or the protective case 10. A user may position the protective case 10 such that solar energy contacts the solar panel to generate electricity for supplemental charging of the electronic device. In aspects, one or more magnets in the protective case 10 and/or an electronic device disposed thereon may be used to facilitate alignment of a supplemental power source (e.g., a wireless charging pad or supplemental battery pack). In aspects, the one or more magnets in the protective case 10 an/or electronic device may be placed a relative position relative to a receiver coil in the electronic device such that, when supplemental power source is attracted to the one or more magnets (e.g., via a magnet associated with the supplemental power source), the receiver coil is aligned with an induction coil of the supplemental power source to provide power to a battery of the electronic device.

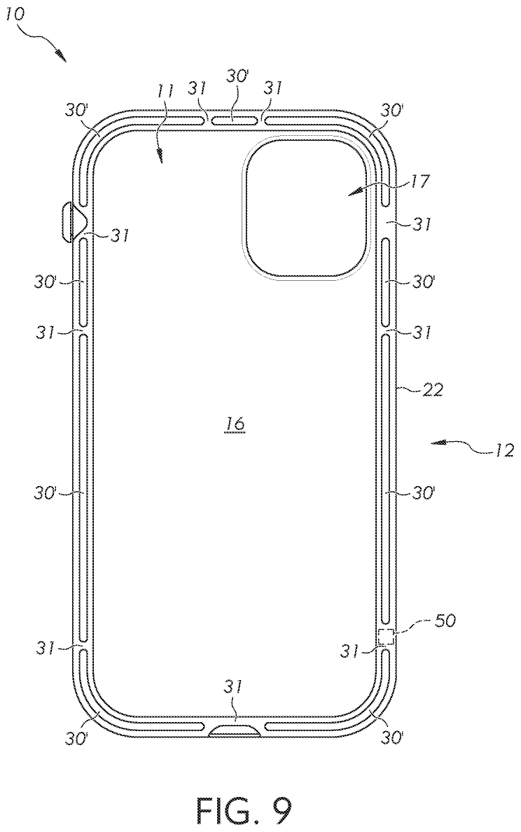

Referring now to FIG. 9, the protective case 10 may include a plurality of elongate apertures 30′ in some aspects. The elongate apertures 30′ may extend along a periphery of the protective case 10. The elongate apertures 30′ may have a length that is greater than a length of the apertures 30 shown in FIG. 1A. Specifically, the elongate apertures 30′ may include an elongated profile, such that the length of the elongate apertures 30′ may be greater than a depth and/or a width of the apertures 30′. In some aspects, the elongated profile of the elongate apertures 30′ may be curvilinear to correspond to the periphery of the protective case 10. The elongate apertures 30′ may extend around substantially the entire periphery of the protective case 10 such that retention components may be attached to the protective case 10 at various locations around the protective case 10. The retention components may be coupled to the elongate apertures 30′ via positive engagement features, negative engagement features, magnets, and/or the like, as described herein. The protective case 10 may include any number of elongate apertures 30′, such as one, two, three, four, or greater than four. The elongate apertures 30′ may be spaced apart with respect to each other such that reinforcement portions 31 of the protective case 10 extend between adjacent elongate apertures 30′. The reinforcement portions 31 of the protective case 10 that extend between adjacent elongate apertures 30′ may act as structural members to maintain the sidewalls 22 of the protective case 10 as a one-piece, monolithic structure. A thickness of the reinforcement portions 31 of the protective case 10 that extend between adjacent elongate apertures 30′ may be larger or smaller to provide additional structural support, or additional space for receiving retention components, respectively. The length of the elongate apertures 30′ may be greater than the thickness of the reinforcement portions 31.

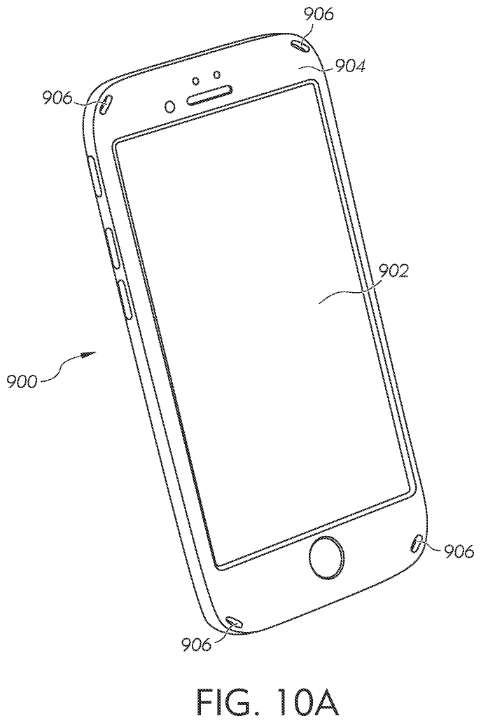

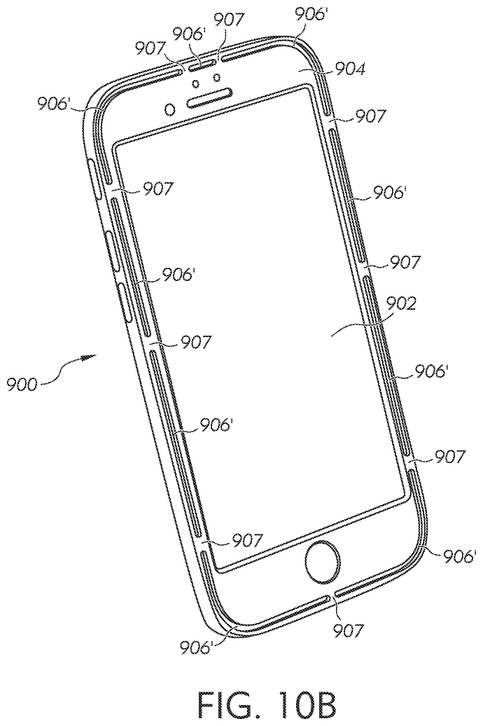

FIG. 10A schematically depicts a perspective view of an electronic device 900. The electronic device 900 includes a display cover 902 covering a display unit (not depicted) of the electronic device 900 and a housing 904. The housing 904 may encapsulate and protect internal components (e.g., processing unit, hard drive, microphones, speakers, network interfaces, and the like) of the electronic device 900. The housing 904 is depicted to include a plurality of apertures 906 disposed therein. In aspects, the plurality of apertures 906 are similar in function, size, and shape to the plurality of apertures 30 of the protective case 10 described herein with respect to FIGS. 1A-9. As such, any of the accessories described herein may be attached directly to the electronic device 900 via the plurality of apertures 906 using a plurality of different retention components. It should be understood that the size, shape, and arrangement of the plurality of apertures 906 depicted in FIG. 10A is only an example and that the plurality of apertures 906 may be arranged differently in alternative aspects. For example, in aspects, rather than being disposed on the corners of the electronic device 900, the plurality of apertures 906 may be disposed on the sides of the housing 904 between the corners. In aspects, one or more of the plurality of apertures 906 may not extend through an entirety of the housing 904 (e.g., from a back surface to a front surface thereof), but rather only partially through the housing. In aspects, in addition to the plurality of apertures 906, the housing 904 and/or display cover 902 may include positive engagement features (e.g., bumps, posts, protrusions, and the like) to facilitate attachment of accessories thereto, as described herein.

With reference to FIG. 10B, in aspects, the housing 904 may include elongate apertures 906′, in some aspects. The elongate apertures 906′ may extend along a periphery of the housing 904. The elongate apertures 906′ may have a length that is greater than a length of the apertures 906 shown in FIG. 10A. The elongate apertures 906′ may include an elongated profile, such that the length of the elongate apertures 906′ may be greater than a depth and/or a width of the apertures 906′. In some aspects, the elongated profile of the elongate apertures 906′ may be curvilinear to correspond to the periphery of the housing 904. The elongate apertures 906′ may extend around substantially the entire periphery of the housing 904 such that retention components may be attached to the housing 904 at various locations around the housing 904. The retention components may be coupled to the elongate apertures 906′ via positive engagement features, negative engagement features, magnets, and/or the like, as described herein. The housing 904 may include any number of elongate apertures 906′, such as one, two, three, four, or greater than four. The elongate apertures 906′ may be spaced apart with respect to each other such that reinforcement portions 907 of the housing 904 extend between adjacent elongate apertures 906′. The reinforcement portions 907 of the housing 904 that extend between adjacent elongate apertures 906′ may act as structural members to maintain the housing 904 as a one-piece, monolithic structure. A thickness of the reinforcement portions 907 of the housing 904 that extend between adjacent elongate apertures 906′ may be larger or smaller to provide additional structural support, or additional space for receiving retention components, respectively. The length of the elongate apertures 906′ may be greater than the thickness of the reinforcement portions 907.

In aspects, the electronic device 900 depicted in FIG. 10A may be inserted into the protective case 10 described herein with respect to FIGS. 1A-9 such that the plurality of apertures 906 and the plurality of apertures 30 (see FIGS. 1A-1B) form a combination of connection points for accessories to the electronic device 900. In aspects, retention components may engage with the plurality of apertures 906, the plurality of apertures 30 in the protective case 10, or both to facilitate attachment of various accessories to the electronic device 900. In aspects, the arrangement of the plurality of apertures 906 in the housing 904 may differ from the arrangement of the plurality of apertures 30 on the protective case 10 (see FIGS. 1A and 1B) to provide a distribution of connection points for a plurality of accessories to the electronic device 900.

It should now be understood that aspects described herein include a protective case that includes a plurality of apertures formed in the protective case. The plurality of apertures generally provide connection points for various accessories that can be attached to the protective case. The apertures of the protective case may be particularly shaped and/or sized to receive retention component, such as an attachment pin, and restrain the attachment pin, thereby holding the various accessories on the protective case, all without hindering operation of the electronic device disposed within the protective case (e.g., blocking the touchscreen of the electronic device, blocking a field of view of an imaging device of the electronic device, blocking one or more buttons, blocking one or more switches, or the like). This provides a distinct advantage over other cases because the protective cases described herein can be customized to a particular user by allowing the user to select which accessories are desired at any particular time, and allows for easy swapping of accessories when desired.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Further aspects of the invention are provided by the subject matter in the following clauses:

A protective case for an electronic device, the protective case comprising: a body defining a cavity for receiving the electronic device, the body comprising one or more walls arranged about a perimeter of the cavity, wherein the one or more walls define a plurality of apertures extending through the body, the plurality of apertures shaped and sized to receive and retain one or more retention components coupled to an accessory.

The protective case of the preceding clause, wherein the one or more walls are arranged about the perimeter to form a plurality of corners of the body.

The protective case of any preceding clause, wherein each one of the plurality of apertures are located in one of the plurality of corners of the body.

The protective case of any preceding clause, wherein each one of the plurality of apertures has a cross sectional shape that corresponds to a shape of a retention component.

The protective case of any preceding clause, wherein: each one of the plurality of apertures is shaped to receive and retain the retention component, and the retention component is an attachment pin having at least one concave surface.

The protective case of any preceding clause, wherein each one of the plurality of apertures has a cross sectional shape that is hourglass shaped.

The protective case of any preceding clause, wherein each one of the plurality of apertures comprises internal surface features that correspond to one or more surface features of a surface of the one or more retention components.

The protective case of any preceding clause, wherein: the body further comprises a rear wall, and the one or more walls are one or more sidewalls that extend transversely from the rear wall.

The protective case of any preceding clause, wherein: the one or more walls are sidewalls that are arranged around the electronic device when the electronic device is disposed within the cavity, the sidewalls comprise a front facing portion and a rear facing portion, and the plurality of apertures extend through the body from the front facing portion to the rear facing portion.

The protective case of any preceding clause, further comprising one or more magnets formed into the body around each of the plurality of apertures.

The protective case of any preceding clause, wherein at least a portion of the body is formed of a magnetic material.

The protective case of any preceding clause, wherein the rear wall of the body includes one or more camera windows that are aligned with one or more components of a camera device on the electronic device when the electronic device is positioned within the protective case.

The protective case of any preceding clause, wherein the rear wall of the body is shaped and sized to generally correspond to the shape and size of the electronic device.

The protective case of any preceding clause, wherein the one or more sidewalls curve over the electronic device when the electronic device is inserted within the cavity such that a portion of the one or more sidewalls covers a portion of a face of the electronic device.

The protective case of any preceding clause, wherein the protective case includes a multi-piece body including a front portion and a rear portion that are separably coupled to one another.

The protective case of any preceding clause, wherein each of the plurality of apertures extends through the entire thickness of the sidewalls, such that the plurality of apertures extend from a front surface of the sidewalls to a rear surface of the sidewalls.

The protective case of any preceding clause, wherein the rear surface of the sidewalls corresponds to a rear surface of the rear wall, such that an entirety of the rear surface of the protective case is substantially planar.

The protective case of any preceding clause, wherein the rear surface of the sidewalls protrudes outward or extends inward from the rear surface of the rear wall such that the sidewalls form a peripheral surface that does not lie in the same plane as the rear wall.

The protective case of any preceding clause, wherein the rear surface of the sidewalls extend beyond the rear wall such that the sidewalls form a ridge that extends around the periphery of the rear wall.

The protective case of any preceding clause, wherein each aperture axis of each of the plurality of apertures extends substantially perpendicular to the rear wall.

The protective case of any preceding clause, wherein the plurality of apertures for the protective case extend through an exterior side of the sidewalls across the corners thereof in a direction that is transverse to the front-to-back direction of the protective case.

The protective case of any preceding clause, wherein the plurality of apertures include an aperture axis that extends in a direction parallel to a tangent line of the curvature of the corner of the protective case.

The protective case of any preceding clause, wherein the plurality of apertures extend through corners of the protective case such that the apertures are not open to the cavity of the protective case, and the interior side of the sidewalls is between the aperture and the cavity.

The protective case of any preceding clause, wherein the cross section of the plurality of apertures is widest at the openings of the aperture and narrowest at a midpoint in between the openings of the aperture

The protective case of any preceding clause, wherein the plurality of apertures include a negative engagement feature, such as a recess, a groove, an indentation, a negative thread, or a concavity, and a positive engagement feature, such as a protrusion, a flange, a positive thread, or a convex portion.

The protective case of any preceding clause, wherein the positive engagement feature corresponds in shape to a negative engagement feature in a retention component used to attach an accessory to the protective case.

The protective case of any preceding clause, wherein the protective case includes a magnet inserted therein in close proximity to one of the plurality of apertures.

The protective case of any preceding clause, wherein the body is formed with one or more receptacles for insertion of the magnet, the receptacle includes at least one of a slot, a groove, and a cavity.

The protective case of any preceding clause, wherein the plurality of apertures includes a base positioned within the body, the base is disposed between the first opening and the second opening of the aperture, substantially in the center of the aperture.

The protective case of any preceding clause, wherein the base, the aperture, and the first opening define a first pocket, and the base, the aperture, and the second opening define a second pocket, each of the first pocket and the second pocket are operable to receive a retention component, and each of the first pocket and the second pocket includes a negative engagement feature and a positive engagement feature.

The protective case of any preceding clause, wherein the base is positioned at an end of the aperture, such that the aperture only includes one of the first opening and the second opening.

The protective case of any preceding clause, wherein the apertures include an elongated profile, such that the length of the apertures is greater than a depth of the apertures.

The protective case of any preceding clause, wherein the apertures are spaced apart such that reinforcement portions of the protective case extend between adjacent apertures, and the length of the apertures are greater than the thickness of the reinforcement portions.

A system, comprising: an accessory; at least one retention component couplable to the accessory; and a protective case for an electronic device, the protective case comprising: a body defining a cavity for receiving the electronic device, the body comprising one or more walls arranged about a perimeter of the cavity, wherein: the one or more walls define a plurality of apertures extending through the body, each one of the plurality of apertures shaped and sized to receive and retain the at least one retention component therein, and the retention component extends at least partially through at least one of the plurality of apertures to attach the accessory to the protective case.

The system of the preceding clause, wherein the accessory is a carabiner accessory or a lanyard accessory.

The system of any preceding clause, wherein: the accessory is a wallet accessory comprising a plurality of accessory apertures that are aligned with the plurality of apertures extending through the body of the protective case, and the at least one retention component comprises a plurality of attachment pins, each one of the plurality of attachment pins shaped and sized to be inserted through one of the plurality of accessory apertures into a corresponding one of the plurality of apertures and held by the corresponding one of the plurality of apertures to retain the wallet accessory against the body of the protective case.

The system of any preceding clause, wherein the wallet accessory comprises: a front portion; a rear portion; and a hinge portion connecting the front portion to the rear portion, wherein: the one or more walls of the protective case rest on the rear portion, the front portion rests on a front surface of the protective case when the wallet accessory is in a closed configuration, and the front portion is foldable relative to the rear portion such that the wallet accessory is removable from the closed configuration to a stand configuration in which an end of the rear portion rests on the front portion to hold the protective case in a viewing position.

The system of any preceding clause, wherein the at least one retention component is an attachment pin comprising a first end, a second end, and a concave surface extending between the first end and the second end.

The system of any preceding clause, wherein: the attachment pin comprises an accessory retention flange disposed toward one of the first end and the second end, the accessory retention flange defines a retention cavity in conjunction with a head portion, and a portion of the accessory is compressed within the retention cavity.

The system of any preceding clause, wherein the at least one retention component is a multi-portion retention element comprising: a lower portion comprising a first insertion portion and a first opening portion extending from the first insertion portion; and an upper portion comprising a second insertion portion and second opening portion extending from the second insertion portion, wherein the first and second insertion portions are inserted into opposite ends of an aperture of the plurality of apertures such that the first and second opening portions contact one another and form an connection opening through which at least a portion of the accessory extends.

The system of any preceding clause, wherein the wallet accessory includes an inner surface with a plurality of slits that function as pockets.

The system of any preceding clause, wherein the hinge portion of the wallet accessory includes a non-overlapping portion that extends from a peripheral edge of the front portion and an overlapping portion extending rearward of the rear portion, the overlapping portion is attached to the rear portion at an edge of the overlapping portion such that a remainder of the overlapping portion is movable relative to the rear portion.

The system of any preceding clause, wherein the front and rear portions of the wallet accessory include a first peripheral region and a second peripheral region, the first peripheral region of the rear portion includes an extension and an attachment strap, the extension includes a closing component having at least one of a magnet, a snap, and a clasp, to facilitate retaining the wallet accessory in a closed position.

The system of any preceding clause, wherein when the wallet accessory is in the closed configuration, the attachment strap forms an opening through which an accessory is configured to be inserted.

The system of any preceding clause, wherein the attachment strap of the wallet accessory is configured to be folded over itself such that an end aperture therein overlaps with one of the plurality of accessory apertures.

The system of any preceding clause, wherein the portion of the attachment strap including the end aperture is secured between the rear portion and the protective case via one of the plurality of retention components.

The system of any preceding clause, wherein: the lower portion of the multi-portion retention element includes a body with a contacting surface extending substantially parallel to the insertion portion and offset from the insertion portion to form a protective case gap extending between the insertion portion and the body, the opening portion of the lower portion includes a mating surface and a mating structure extending from the mating surface, the upper portion includes a body defining a contacting surface that is offset from the insertion portion to form a protective case gap, the opening portion includes a mating surface and a mating structure extending from the mating surface, the mating surface is structured to conform to the mating surface of the lower portion such that the lower portion and the upper portion combine to form a substantially continuous body when inserted in the aperture.

The system of any preceding clause, wherein: the body of the lower portion includes an underlying portion that underlies the body of the upper portion, the body of the upper portion includes an overlying portion that overlies the body of the lower portion, the underlying portion and the overlying portion are disposed at different locations in the substantially continuous body to prevent the lower portion and the upper portion from twisting relative to one another and maintain the shape of the substantially continuous body when installed on the protective case.

The system of any preceding clause, wherein: the first retention component includes a first attachment loop attached to a first end of the first accessory via a clip assembly and a second attachment loop attached to a second end of the first accessory via an attachment member, the first and second attachment loops are attached to the protective case by initially routing the first and second attachment loops through different ones of the plurality of apertures and then routing the first accessory through both of the first and second attachment loops, the attachment member is a plastic housing to which both the second attachment loop and the first accessory are attached, and the attachment member includes an opening through which the second attachment loop extends to render the second attachment loop accessible.

The system of any preceding clause, wherein the second accessory is a ring stand including a base and a support portion that are attached to one another via a rotatable connection, the rotatable connection facilitates pivoting the support portion relative to the base about a pivot axis to facilitate placing the second accessory in a plurality of different configurations.

A protective system for an electronic device, the protective system comprising: a protective case comprising a body comprising one or more sidewalls and a rear wall, wherein the one or more sidewalls define a plurality of apertures extending through the body, each one of the plurality of apertures shaped and sized to receive and retain at least one retention component therein; a first accessory attached to the protective case by a retention component extending through a first set of the plurality of apertures; and a second accessory attached to the protective case at a position other than the first set of the plurality of apertures.

The protective system of the preceding clause, wherein the position other than the first set of the plurality of apertures comprises: a second set of the plurality of apertures that is different than the first set of the plurality of apertures; or a rear surface of the body of the protective case.

An electronic device comprising a display cover covering a display unit of the electronic device and a housing, the housing encapsulates and protects internal components of the electronic device and includes a plurality of apertures disposed therein.

The electronic device of the preceding clause, further comprising the apertures of any preceding clause.

While particular aspects have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A protective case for an electronic device, the protective case comprising:
a body defining a cavity for receiving the electronic device, the body comprising one or more walls arranged about a perimeter of the cavity,
wherein the one or more walls define a plurality of apertures extending through the body, the plurality of apertures shaped and sized to receive and retain one or more retention components coupled to an accessory.

2. The protective case of claim 1, wherein the one or more walls are arranged about the perimeter to form a plurality of corners of the body.

3. The protective case of claim 2, wherein each one of the plurality of apertures are located in one of the plurality of corners of the body.

4. The protective case of claim 1, wherein each one of the plurality of apertures has a cross sectional shape that corresponds to a shape of a retention component.

5. The protective case of claim 4, wherein:
each one of the plurality of apertures is shaped to receive and retain the retention component, and
the retention component is an attachment pin having at least one concave surface.

6. The protective case of claim 1, wherein each one of the plurality of apertures has a cross sectional shape that is hourglass shaped.

7. The protective case of claim 1, wherein each one of the plurality of apertures comprises internal surface features that correspond to one or more surface features of a surface of the one or more retention components.

8. The protective case of claim 1, wherein:
the body further comprises a rear wall, and
the one or more walls are one or more sidewalls that extend transversely from the rear wall.

9. The protective case of claim 1, wherein:
the one or more walls are sidewalls that are arranged around the electronic device when the electronic device is disposed within the cavity,
the sidewalls comprise a front facing portion and a rear facing portion, and
the plurality of apertures extend through the body from the front facing portion to the rear facing portion.

10. The protective case of claim 1, further comprising one or more magnets formed into the body around each of the plurality of apertures.

11. The protective case of claim 1, wherein at least a portion of the body is formed of a magnetic material.

12. A system, comprising:
an accessory;
at least one retention component couplable to the accessory; and
a protective case for an electronic device, the protective case comprising:
a body defining a cavity for receiving the electronic device, the body comprising one or more walls arranged about a perimeter of the cavity,
wherein:
the one or more walls define a plurality of apertures extending through the body, each one of the plurality of apertures shaped and sized to receive and retain the at least one retention component therein, and
the retention component extends at least partially through at least one of the plurality of apertures to attach the accessory to the protective case.

13. The system of claim 12, wherein the accessory is a carabiner accessory or a lanyard accessory.

14. The system of claim 12, wherein:
the accessory is a wallet accessory comprising a plurality of accessory apertures that are aligned with the plurality of apertures extending through the body of the protective case, and
the at least one retention component comprises a plurality of attachment pins, each one of the plurality of attachment pins shaped and sized to be inserted through one of the plurality of accessory apertures into a corresponding one of the plurality of apertures and held by the corresponding one of the plurality of apertures to retain the wallet accessory against the body of the protective case.

15. The system of claim 14, wherein the wallet accessory comprises:
a front portion;
a rear portion; and
a hinge portion connecting the front portion to the rear portion, wherein:
the one or more walls of the protective case rest on the rear portion,
the front portion rests on a front surface of the protective case when the wallet accessory is in a closed configuration, and
the front portion is foldable relative to the rear portion such that the wallet accessory is removable from the closed configuration to a stand configuration in which an end of the rear portion rests on the front portion to hold the protective case in a viewing position.

16. The system of claim 12, wherein the at least one retention component is an attachment pin comprising a first end, a second end, and a concave surface extending between the first end and the second end.

17. The system of claim 16, wherein:
the attachment pin comprises an accessory retention flange disposed toward one of the first end and the second end,
the accessory retention flange defines a retention cavity in conjunction with a head portion, and
a portion of the accessory is compressed within the retention cavity.

18. The system of claim 12, wherein the at least one retention component is a multi-portion retention element comprising:
a lower portion comprising a first insertion portion and a first opening portion extending from the first insertion portion; and
an upper portion comprising a second insertion portion and second opening portion extending from the second insertion portion, wherein the first and second insertion portions are inserted into opposite ends of an aperture of the plurality of apertures such that the first and second opening portions contact one another and form an connection opening through which at least a portion of the accessory extends.

19. A protective system for an electronic device, the protective system comprising:
a protective case comprising a body comprising one or more sidewalls and a rear wall, wherein the one or more sidewalls define a plurality of apertures extending through the body, each one of the plurality of apertures shaped and sized to receive and retain at least one retention component therein;
a first accessory attached to the protective case by a retention component extending through a first set of the plurality of apertures; and
a second accessory attached to the protective case at a position other than the first set of the plurality of apertures.

20. The protective system of claim 19, wherein the position other than the first set of the plurality of apertures comprises:
a second set of the plurality of apertures that is different than the first set of the plurality of apertures; or
a rear surface of the body of the protective case.
